(19) United States
(12) Patent Application Publication
(10) Pub. No.: US 2026/0184073 A1
(43) Pub. Date: Jul. 2, 2026

(54) LIQUID EJECTING HEAD

(71) Applicant: SEIKO EPSON CORPORATION, Tokyo (JP)

(72) Inventors: Takeshi ITO, SHIOJIRI-SHI (JP); Shuichi KOGANEHIRA, MATSUMOTO-SHI (JP)

(21) Appl. No.: 19/428,426

(22) Filed: Dec. 22, 2025

(30) Foreign Application Priority Data
Dec. 26, 2024 (JP) 2024-230426

(51) Int. Cl. B41J 2/14

(52) U.S. Cl. CPC B41J 2/14233; B41J 2002/14306

(57) ABSTRACT

A liquid ejecting head includes: a nozzle configured to eject liquid; a first flow path member and a second flow path member that constitute a flow path communicating with the nozzle; and a first bonding portion that liquid-tightly couples the first flow path member and the second flow path member to constitute the flow path, in which the first flow path member includes a light-transmitting portion having light-transmitting properties for confirming a degree of deterioration of the first bonding portion from an outside of the first flow path member.

The present application is based on, and claims priority from JP Application Serial Number 2024-230426, filed December 26, 2024, the disclosure of which is hereby incorporated by reference herein in its entirety.

### BACKGROUND

### 1. Technical Field

The present disclosure relates to a liquid ejecting head.

### 2. Related Art

In the related art, a liquid ejecting head that ejects liquid such as ink from a nozzle is widely used. For example, JP-A-2023-100338 discloses that a plurality of flow path members constituting a flow path of a liquid ejecting head are joined to each other with an adhesive, thereby liquid-tightly coupling flow paths formed in the plurality of joined flow path members.

The adhesive joining the flow path members deteriorates upon contact with liquid flowing through the flow path, and the liquid in the flow path may leak out from a bonded portion to an outside of the flow path members. However, in the related art mentioned above, there is a problem in that a user of the liquid ejecting head cannot determine when the liquid ejecting head should be replaced.

### SUMMARY

According to a preferred aspect of the present disclosure, there is provided a liquid ejecting head including: a nozzle that ejects liquid; a first flow path member and a second flow path member that constitute a flow path communicating with the nozzle; and a first bonding portion that liquid-tightly couples the first flow path member and the second flow path member to constitute the flow path, in which the first flow path member includes a light-transmitting portion having light-transmitting properties for confirming a degree of deterioration of the first bonding portion from an outside of the first flow path member.

### BRIEF DESCRIPTION OF THE DRAWINGS

FIG. 1 is a schematic diagram showing a configuration example of an ink jet system according to a first embodiment.

FIG. 2 is a diagram showing a configuration of a processing apparatus.

FIG. 3 is a block diagram showing a configuration example of an ink jet printer.

FIG. 4 is a configuration diagram of the ink jet printer.

FIG. 5 is an exploded perspective view of a liquid ejecting head.

FIG. 6 is a cross-sectional view of the liquid ejecting head taken along line VI-VI in FIG. 5.

FIG. 7 is an enlarged view of a vicinity of an ink hole shown in FIG. 6.

FIG. 8 is a cross-sectional view of a head unit taken along an X-axis direction through a wiring hole.

FIG. 9 is a plan view schematically showing an inside of the head unit.

FIG. 10 is a plan view exemplifying an in-structure flow path.

FIG. 11 is a side view of an in-structure supply flow path and an in-structure discharge flow path.

FIG. 12 is a side view of an in-structure supply flow path and an in-structure discharge flow path.

FIG. 13 is a view illustrating a light-transmitting portion.

FIG. 14 is a view illustrating a light-transmitting portion in a second embodiment.

FIG. 15 is a view illustrating a light-transmitting portion in a first modification example.

FIG. 16 is a view illustrating a light-transmitting portion in a second modification example.

FIG. 17 is a view illustrating a light-transmitting portion in a third modification example.

FIG. 18 is a view illustrating light-transmitting portions in a fourth modification example.

FIG. 19 is a view illustrating a light-transmitting portion in a fifth modification example.

FIG. 20 is a view illustrating a light-transmitting portion in a sixth modification example.

### DESCRIPTION OF EMBODIMENTS

Hereinafter, embodiments for implementing the present disclosure will be described with reference to the drawings. Note that, in the drawings, dimensions and scales of each portion are made different from actual ones as appropriate. In addition, since embodiments to be described below are preferred specific examples of the present disclosure, various technically preferable limitations are imposed. However, the scope of the present disclosure is not limited to these embodiments unless there is a description in the following description that particularly limits the present disclosure.

Hereinafter, for convenience of description, one direction along an X-axis from any point will be referred to as an X1 direction, and a direction opposite to the X1 direction will be referred to as an X2 direction. The X1 direction and the X2 direction are collectively referred to as a direction along the X-axis. Similarly, directions opposite to each other along a Y-axis from any point will be referred to as a Y1 direction and a Y2 direction, and directions opposite to each other along a Z-axis from any point will be referred to as a Z1 direction and a Z2 direction. The Y1 direction and the Y2 direction are collectively referred to as a direction along the Y-axis. The Z1 direction and the Z2 direction are collectively referred to as a direction along the Z-axis. The direction along the X-axis and the direction along the Y-axis are orthogonal to each other. The direction along the X-axis and the direction along the Z-axis are orthogonal to each other. The direction along the Y-axis and the direction along the Z-axis are orthogonal to each other. An X-Y plane including the X-axis and the Y-axis corresponds to a horizontal plane. The Z-axis is an axis along a vertical direction, the Z1 direction corresponds to an upper side in the vertical direction, and the Z2 direction corresponds to a lower side in the vertical direction. Additionally, viewing in the direction along the Z-axis may be referred to as "plan view".

### 1. First Embodiment

### 1-1. Overview of Ink Jet System SYS

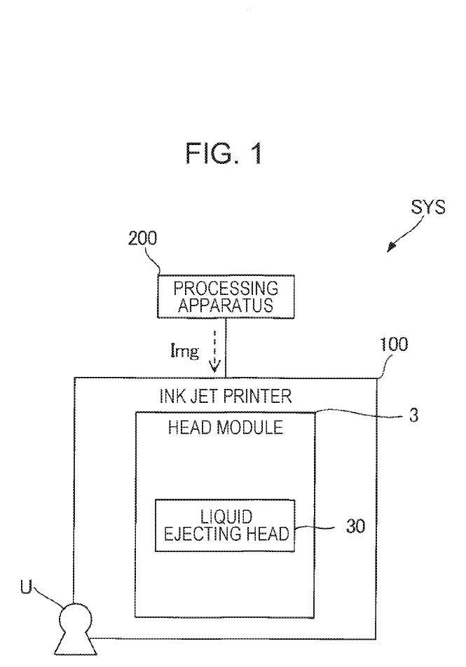

FIG. 1 is a schematic diagram showing a configuration example of an ink jet system SYS according to a first embodiment. The ink jet system SYS is a system that provides a service of forming an image on a medium PP, which will be described below, by using an ink jet method. The ink jet system SYS includes an ink jet printer 100 and a processing apparatus 200.

Here, the ink jet printer 100 is an apparatus provided by a manufacturer of the ink jet printer 100. The ink jet printer 100 is a liquid ejecting apparatus that ejects ink, which is an example of liquid. The manufacturer of the ink jet printer 100 is a company that manufactures the ink jet printer 100. The manufacturer of the ink jet printer 100 may be referred to as a "printer manufacturer". A liquid ejecting head 30 incorporated into the ink jet printer 100 is provided by a manufacturer of the liquid ejecting head 30. The manufacturer of the liquid ejecting head 30 is a company that manufactures the liquid ejecting head 30. Hereinafter, the manufacturer of the liquid ejecting head 30 may be referred to as a "head manufacturer". The printer manufacturer receives provision of the liquid ejecting head 30 from the head manufacturer and manufactures the ink jet printer 100 by incorporating the provided liquid ejecting head 30 into the ink jet printer 100. The ink jet printer 100 is an example of a "liquid ejecting apparatus".

FIG. 1 shows a user U who uses the ink jet printer 100. As the user U, for example, when an operator belonging to the printer manufacturer uses the ink jet printer 100, this operator is the user U. In addition, for example, when a third party who receives the provision of the ink jet printer 100 from the printer manufacturer uses the ink jet printer 100, this third party is the user U. The user U uses the processing apparatus 200 in addition to the ink jet printer 100.

The ink jet printer 100 receives image data Img indicating an image from the processing apparatus 200. The ink jet printer 100 forms an image based on the image data Img on the medium PP. Hereinafter, a process of forming an image on the medium PP may be referred to as a "printing process".

The ink jet printer 100 includes one head module 3 including one liquid ejecting head 30.

The processing apparatus 200 is a computer such as a desktop type or a notebook type. The processing apparatus 200 may be provided as a part of the ink jet printer 100.

### 1-2. Concerning Failure of Liquid Ejecting Head 30

The liquid ejecting head 30 provided in the ink jet printer 100 may fail because of aging deterioration or the like. One reason for failure of the liquid ejecting head 30 is that a bonding portion that bonds two flow path members constituting a flow path in the liquid ejecting head 30 to liquid-tightly couple flow paths of the two flow path members may come into contact with ink for a long period of time, thereby undergoing either or both of deterioration due to wear caused by a flow velocity or the like and deterioration due to elution of an adhesive into the ink caused by attack by the ink. Consequently, the flow paths of the two flow path members cannot be liquid-tightly coupled, and ink may leak out of the flow path from a location where liquid-tight coupling is no longer possible. Hereinafter, a case where the adhesive can no longer seal a gap between the flow paths of the two flow path members may be referred to as "seal failure". When seal failure occurs, ink may leak out of the flow path from a location where the seal failure occurs. When ink leaks out of the flow path, the ink may adhere to an electronic circuit in the liquid ejecting head 30 to cause failure, or an inside or a periphery of the ink jet printer 100 may become contaminated with the ink.

Accordingly, there is provided a liquid ejecting head 30 capable of detecting a sign of ink leakage from the liquid ejecting head 30, before the liquid ejecting head 30 fails because of ink leaking out of the flow path from the location where seal failure occurs. The sign of ink leakage from the liquid ejecting head 30 includes that ink will soon leak from the liquid ejecting head 30, and estimation of a lifetime of the liquid ejecting head 30, that is, estimation of a time point at which ink will leak from the liquid ejecting head 30.

### 1-3. Configuration of Processing Apparatus 200

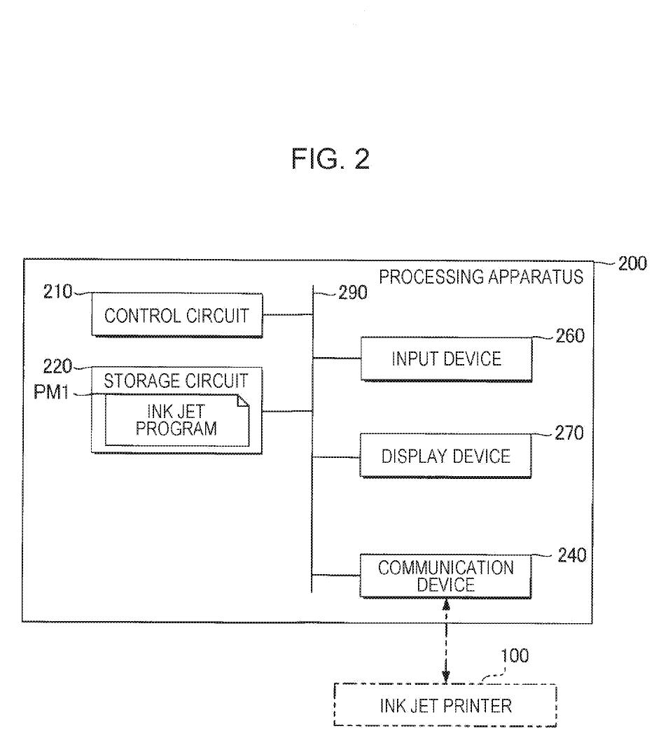

FIG. 2 is a diagram showing a configuration of the processing apparatus 200. The processing apparatus 200 includes a control circuit 210, a storage circuit 220, a communication device 240, an input device 260, and a display device 270. The control circuit 210, the storage circuit 220, the communication device 240, the input device 260, and the display device 270 are mutually connected by a bus 290 for information communication.

The control circuit 210 includes, for example, one or more processors such as a central processing unit (CPU). The control circuit 210 may include a programmable logic device such as a field-programmable gate array (FPGA) instead of the CPU or in addition to the CPU.

The storage circuit 220 is configured with a magnetic storage device, a flash ROM, or the like. The storage circuit 220 is readable by the control circuit 210 and stores a plurality of programs including an ink jet program PM1 executed by the control circuit 210, various kinds of information used by the control circuit 210, and the like. The storage circuit 220 includes, for example, semiconductor memories of one or both of one or more volatile memories, such as a RAM, and one or more non-volatile memories, such as a ROM, an EEPROM, or a PROM. The ink jet program PM1 is, for example, a program for generating the image data Img.

The communication device 240 is a circuit that can communicate with the ink jet printer 100. For example, the communication device 240 is a network card, such as a Universal Serial Bus (USB) or Bluetooth. USB and Bluetooth are registered trademarks.

The input device 260 is a device that outputs operation information corresponding to an operation of the user U. The input device 260 is, for example, a mouse and a keyboard.

The display device 270 displays an image indicating some kind of information to the user U. The display device 270 is an organic electro-luminescence (EL) display, a light emitting diode (LED) display, and a liquid crystal display (LCD). Additionally, the input device 260 and the display device 270 may be configured integrally. A configuration in which the input device 260 and the display device 270 are integral is, for example, a touch panel.

### 1-4. Overview of Ink Jet Printer 100

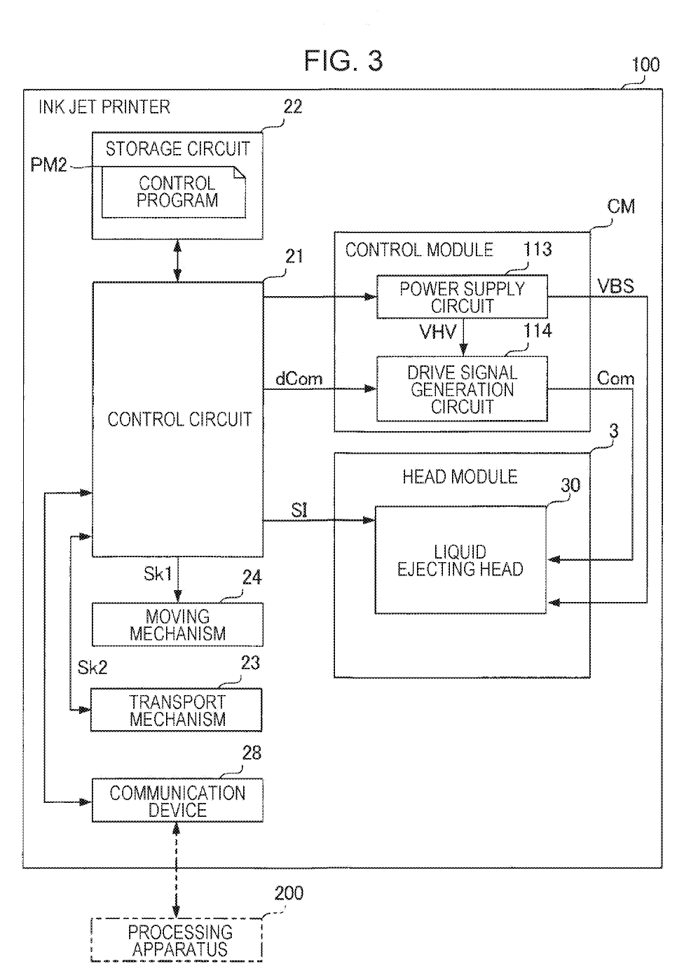

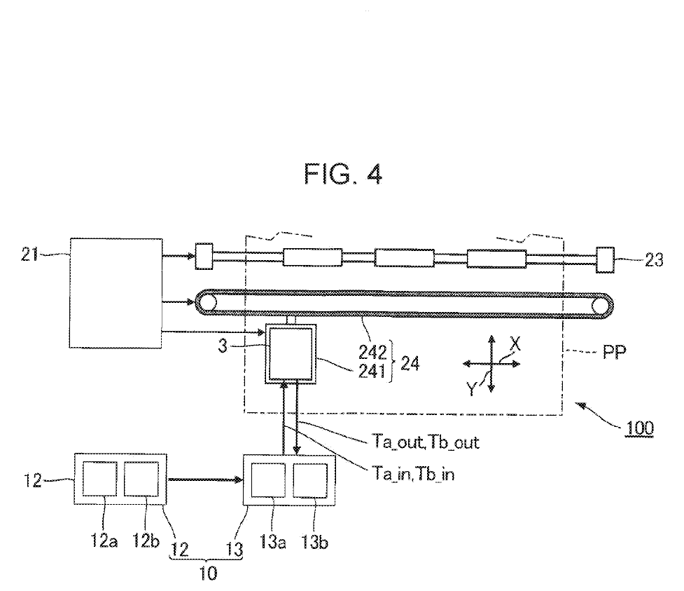

FIG. 3 is a block diagram showing a configuration example of the ink jet printer 100. FIG. 4 is a configuration diagram of the ink jet printer 100. The ink jet printer 100 shown in FIG. 4 is an ink jet type printing apparatus that ejects ink as droplets onto the medium PP. The ink is an example of "liquid". The medium PP is, for example, printing paper. However, the medium PP is not limited to printing paper and may be, for example, a printing target of any material, such as a resin film or fabric.

As shown in FIGS. 3 and 4, the ink jet printer 100 includes a control module CM, a liquid supply system 10, a control circuit 21, a storage circuit 22, a transport mechanism 23, a moving mechanism 24, the head module 3, and a communication device 28.

The control module CM includes a power supply circuit 113 and a drive signal generation circuit 114. The power supply circuit 113 receives supply of electric power from a commercial power source (not shown) and generates various predetermined potentials. The various generated potentials are supplied to each portion of the ink jet printer 100 as appropriate. In the example shown in FIG. 3, the power supply circuit 113 generates a power supply potential VHV and an offset potential VBS. The offset potential VBS is supplied to the liquid ejecting head 30. Additionally, the power supply potential VHV is supplied to the drive signal generation circuit 114 and the like.

The drive signal generation circuit 114 is a circuit that generates a drive signal Com for driving the liquid ejecting head 30. Specifically, the drive signal generation circuit 114 includes, for example, a DA conversion circuit and an amplification circuit. In the drive signal generation circuit 114, the DA conversion circuit converts a waveform designation signal dCom, which will be described below, from the control circuit 21 from a digital signal into an analog signal, and the amplification circuit generates the drive signal Com by amplifying the analog signal using the power supply potential VHV from the power supply circuit 113.

The liquid supply system 10 includes a liquid container 12 and a sub tank 13. The liquid container 12 stores ink. The sub tank 13 temporarily stores ink supplied from the liquid container 12.

The liquid container 12 includes, for example, a cartridge that is attachable to and detachable from the ink jet printer 100, a bag-shaped ink pack formed of a flexible film, or an ink tank capable of being refilled with ink. The liquid container 12 includes liquid containers 12a and 12b. For example, different color inks are stored in the liquid containers 12a and 12b. A first ink is stored in the liquid container 12a. For example, a second ink having a color different from that of the first ink is stored in the liquid container 12b.

The sub tank 13 includes sub tanks 13a and 13b. The sub tank 13a is coupled to the liquid container 12a and temporarily stores the first ink. The sub tank 13b is coupled to the liquid container 12b and temporarily stores the second ink. In addition, a supply tube Ta_in and a discharge tube Ta_out are coupled to the sub tank 13a. A supply tube Tb_in and a discharge tube Tb_out are coupled to the sub tank 13b. These tubes are coupled to the head module 3. Such a sub tank 13 supplies ink to the head module 3 and collects ink from the head module 3. Accordingly, ink circulates between the sub tank 13 and the head module 3.

The ink is, for example, an aqueous pigment ink, a solvent ink, or an ultraviolet curable ink. The solvent ink is an ink containing an organic solvent. The solvent ink is an ink in which, after being applied to the medium PP, the organic solvent penetrates into the medium PP to form a receiving layer, and a color material is fixed on the receiving layer. The ultraviolet curable ink is an ink containing an ultraviolet curable component. Hereinafter, the ultraviolet curable ink will be referred to as an ultraviolet (UV) ink. The ultraviolet curable component contains a monomer or an oligomer. The UV ink is ink in which, after being applied to the medium PP, the ultraviolet curable component is cured by irradiation with ultraviolet rays, and a color material is fixed in a coating formed by curing of the ultraviolet curable component.

The storage circuit 22 stores various programs including a control program PM2 executed by the control circuit 21 and various kinds of data such as the image data Img processed by the control circuit 21. The storage circuit 22 includes, for example, semiconductor memories of one or both of one or more volatile memories, such as a RAM, and one or more non-volatile memories, such as a ROM, an EEPROM, or a PROM. The storage circuit 22 may be configured as a part of the control circuit 21.

The transport mechanism 23 transports the medium PP along the Y-axis under the control of the control circuit 21. The moving mechanism 24 reciprocates the head module 3 along the X-axis under the control of the control circuit 21.

The moving mechanism 24 includes a substantially box-shaped support 241 that accommodates the head module 3, and an endless belt 242 to which the support 241 is fixed.

The communication device 28 is a circuit that can communicate with the processing apparatus 200. For example, the communication device 28 is a network card, such as USB or Bluetooth. In addition, the communication device 28 may be integrated with the control circuit 21.

The head module 3 ejects ink supplied from the sub tank 13 onto the medium PP under the control of the control circuit 21. By ejecting ink from the head module 3 onto the medium PP in parallel with transport of the medium PP by the transport mechanism 23 and repetitive reciprocation of the support 241, an image is formed on a surface of the medium PP. Ink not ejected from the head module 3 is discharged to the sub tank 13. The head module 3 includes one liquid ejecting head 30, but may include a plurality of liquid ejecting heads 30.

The description returns to FIGS. 3 and 4. The control circuit 21 controls each element provided in the ink jet printer 100. The control circuit 21 includes, for example, one or more of processing circuits, such as a CPU or an FPGA, and one or more of storage circuits, such as a semiconductor memory.

The control circuit 21 controls the operation of each portion of the ink jet printer 100 by executing a program stored in the storage circuit 22. Here, the control circuit 21 generates signals such as a control signal Sk1, a control signal Sk2, a print signal SI, and a waveform designation signal dCom, as signals for controlling the operation of each portion of the ink jet printer 100.

The control signal Sk1 is a signal for controlling driving of the moving mechanism 24. The control signal Sk2 is a signal for controlling driving of the transport mechanism 23. The print signal SI is a signal for controlling driving of the liquid ejecting head 30. The waveform designation signal dCom is a digital signal for defining a waveform of the drive signal Com generated by the drive signal generation circuit 114.

### 1-5. Overall Configuration of Liquid Ejecting Head 30

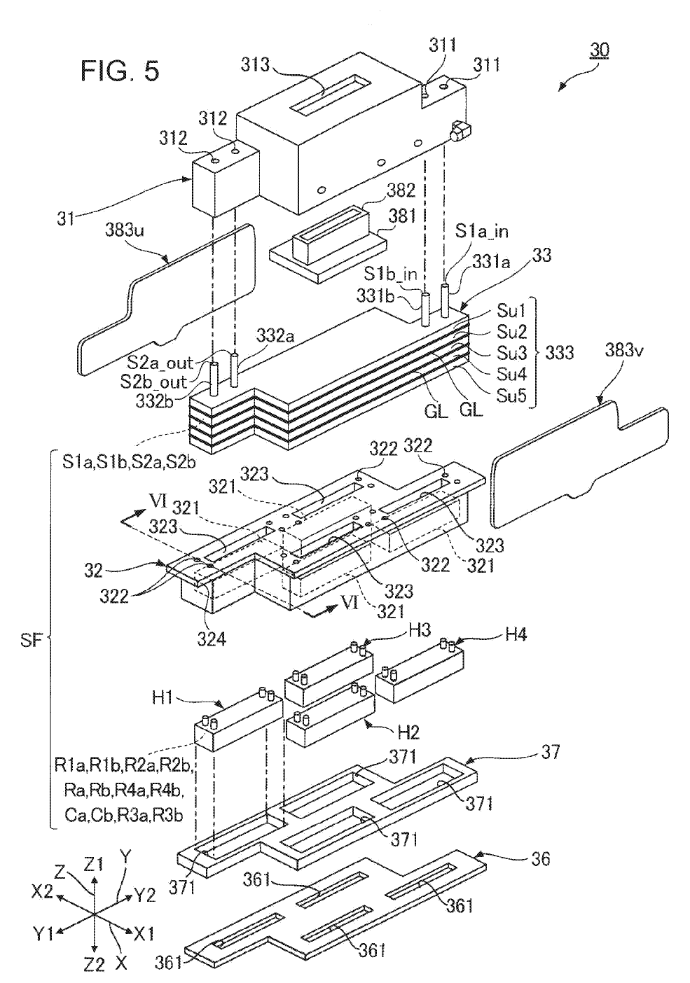

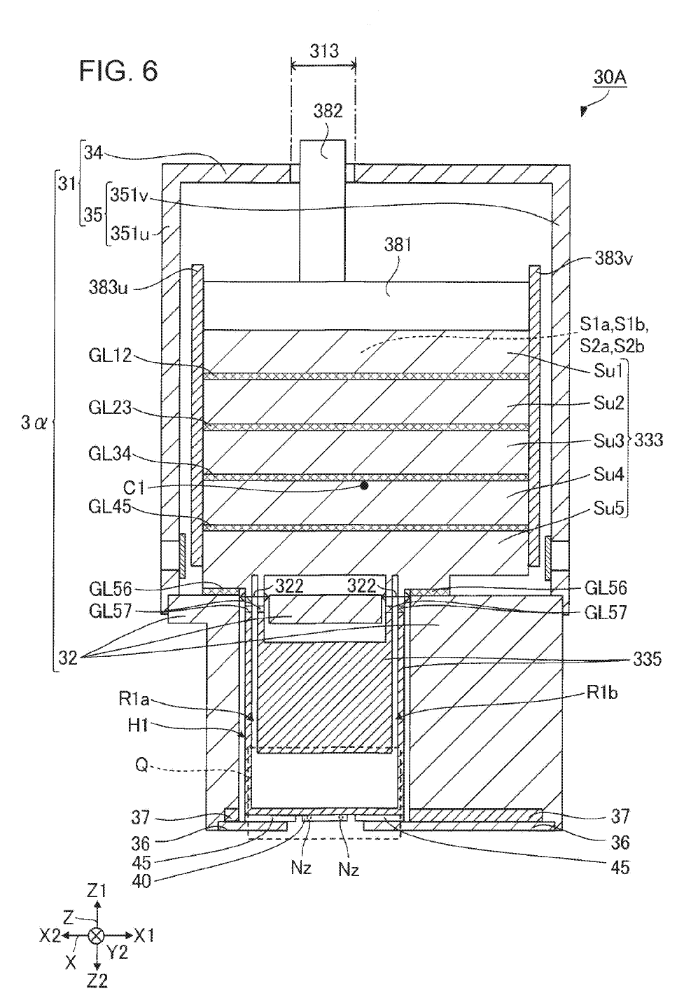

FIG. 5 is an exploded perspective view of the liquid ejecting head 30. FIG. 6 is a cross-sectional view of the liquid ejecting head 30 taken along line VI-VI in FIG. 5. The view shown in FIG. 6 is a view of a cross-section of the liquid ejecting head 30 taken along line VI-VI as viewed in the Y2 direction. The line VI-VI is an imaginary line segment passing through two ink holes 322 and along the X-axis direction.

As shown in FIG. 5, the liquid ejecting head 30 includes a housing 3α, a flow path structure 33, a fixing plate 36, and a reinforcing plate 37. Additionally, the liquid ejecting head 30 includes a plurality of head units H1, H2, H3, and H4. The head units H1, H2, H3, and H4 are referred to as a head unit Hn unless otherwise distinguished. In addition, the liquid ejecting head 30 includes electrical elements such as a wiring substrate 381, a wiring member 382, and circuit boards 383u and 383v. Further, the flow path structure 33 includes a laminate 333, supply coupling portions 331a and 331b, and discharge coupling portions 332a and 332b. Hereinafter, each element provided in the liquid ejecting head 30 will be described with reference to FIGS. 5 and 6.

The housing 3α shown in FIGS. 5 and 6 is a hollow case that accommodates the head unit Hn and the laminate 333. The housing 3α includes a cover member 31 and a holder member 32.

The cover member 31 accommodates the laminate 333. The holder member 32 accommodates the plurality of head units Hn. In the present embodiment, the holder member 32 accommodates four head units Hn. The holder member 32 is disposed in the Z2 direction with respect to the cover member 31.

As shown in FIG. 5, the cover member 31 includes two first coupling portion holes 311, two second coupling portion holes 312, and a first hole 313. The first hole 313 is a hole through which the wiring member 382 is inserted. One of the supply coupling portions 331a and 331b is inserted through and fitted into each first coupling portion hole 311. One of the discharge coupling portions 332a and 332b is inserted through and fitted into each second coupling portion hole 312.

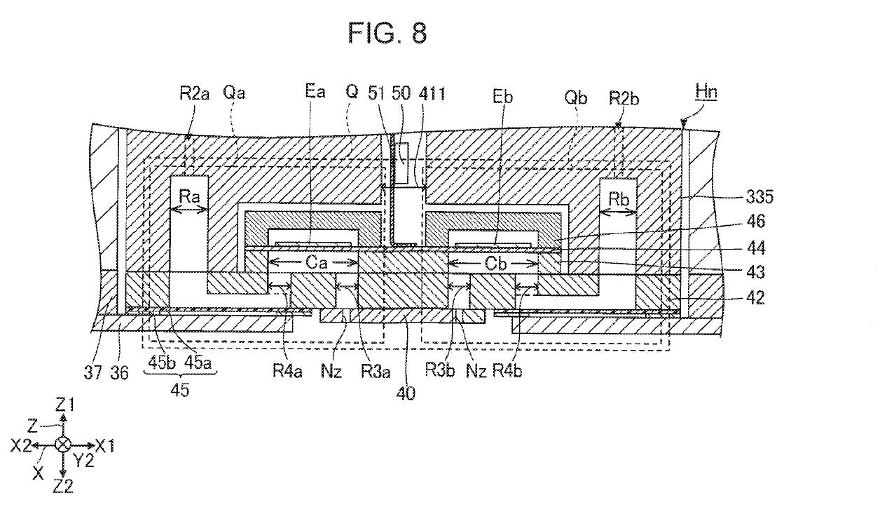

The holder member 32 includes a plurality of recessed portions 321, a plurality of ink holes 322, and a plurality of wiring holes 323. Each recessed portion 321 is a depression that is open in the Z2 direction. The head unit Hn is disposed in each recessed portion 321. Each ink hole 322 is a hole through which ink flows between the flow path structure 33 and the head unit Hn. Each wiring hole 323 communicates with the recessed portion 321. Each wiring hole 323 is a hole through which a flexible substrate 51 shown in FIG. 8 is passed. The flexible substrate 51 is provided for each head unit Hn and is electrically coupled to the head unit Hn. As shown in FIG. 5, the holder member 32 includes a flange portion 324 for fixing the holder member 32 to the support 241.

As shown in FIG. 6, the housing 3α includes an upper wall portion 34 and a side wall portion 35. The side wall portion 35 includes a side wall 351u and a side wall 351v.

As shown in FIG. 5, the laminate 333 of the flow path structure 33 includes a plurality of flow path plates Su1, Su2, Su3, Su4, and Su5, and the plurality of flow path plates Su1, Su2, Su3, Su4, and Su5 are referred to as a flow path plate Su unless otherwise distinguished. Each flow path plate Su is formed by, for example, injection molding of a resin, but may also be formed of a metal.

The flow path plates Su1 to Su5 are bonded to each other by an adhesive that forms bonding portions GL12, GL23, GL34, and GL45. The flow path plate Su5 is bonded in the Z1 direction to the holder member 32 by an adhesive that forms a bonding portion GL56. In the following description, a layer formed by an adhesive in the liquid ejecting head 30 is collectively referred to as a bonding portion GL. The bonding portion GL liquid-tightly couples two members. An adhesive forming the bonding portion GL is, for example, an epoxy-based adhesive containing an epoxy resin as a main component, but may also be a silicone-based adhesive or the like.

The liquid ejecting head 30 includes a flow path SF communicating with the nozzle Nz inside. The flow path SF includes in-structure supply flow paths S1a and S1b, in-structure discharge flow paths S2a and S2b, in-head supply flow paths R1a and R1b, in-head discharge flow paths R2a and R2b, a first liquid storage chamber Ra, a second liquid storage chamber Rb, second communication flow paths R4a and R4b, pressure chambers Ca and Cb, and first communication flow paths R3a and R3b.

The laminate 333 includes the in-structure supply flow paths S1a and S1b and the in-structure discharge flow paths S2a and S2b. The in-structure supply flow paths S1a and S1b and the in-structure discharge flow paths S2a and S2b are referred to as an in-structure flow path Sn unless otherwise distinguished. Each in-structure flow path Sn is a space formed in the laminate 333. The ink flows through the in-structure flow path Sn. Each in-structure flow path Sn is formed by one or both of grooves along an X-Y plane provided in each of two flow path plates Su adjacent to each other, and a hole in the flow path plate Su that extends in the Z-axis direction. In FIG. 6, the in-structure flow path Sn is not shown in order to prevent the drawing from being complicated.

Specifically, the in-structure supply flow path S1a supplies the first ink stored in the sub tank 13a to the plurality of head units Hn. The in-structure supply flow path S1b supplies the second ink stored in the sub tank 13b to the plurality of head units Hn. The in-structure discharge flow path S2a discharges the first ink that is not ejected from the plurality of head units Hn to the sub tank 13a. The in-structure discharge flow path S2b discharges the second ink that is not ejected from the plurality of head units Hn to the sub tank 13b. A filter portion Fa including a filter that captures foreign matter or bubbles mixed into ink may be installed in each in-structure flow path Sn.

Each of the supply coupling portions 331a and 331b and the discharge coupling portions 332a and 332b is provided in the Z1 direction with respect to the laminate 333 and protrudes from the laminate 333 in the Z1 direction. Each of the supply coupling portions 331a and 331b and the discharge coupling portions 332a and 332b is a coupling tube for communication between each in-structure flow path Sn and the outside of the housing 3α.

Specifically, the supply coupling portion 331a is a supply tube through which the first ink is supplied from the sub tank 13a to the in-structure supply flow path S1a, and is provided with a supply port S1a_in for supplying the first ink to the laminate 333. The supply coupling portion 331b is a supply tube through which the second ink is supplied from the sub tank 13b to the in-structure supply flow path S1b, and is provided with a supply port S1b_in for supplying the second ink to the laminate 333. The discharge coupling portion 332a is a discharge tube through which the first ink is discharged from the in-structure discharge flow path S2a to the sub tank 13a, and is provided with a discharge port S2a_out for discharging the first ink from the laminate 333. The discharge coupling portion 332b is a discharge tube through which the second ink is discharged from the in-structure discharge flow path S2b to the sub tank 13b, and is provided with a discharge port S2b_out for discharging the second ink from the laminate 333.

The head unit Hn includes the in-head supply flow paths R1a and R1b, the in-head discharge flow paths R2a and R2b, and a liquid ejecting portion Q that ejects ink. The first liquid storage chamber Ra, the second liquid storage chamber Rb, the second communication flow paths R4a and R4b, the pressure chambers Ca and Cb, and the first communication flow paths R3a and R3b are provided in the liquid ejecting portion Q. The flow paths provided in the liquid ejecting portion Q are shown in FIG. 8.

In FIG. 6, the detailed shape of the liquid ejecting portion Q is not shown in order to prevent the drawing from being complicated. The detailed shape of the liquid ejecting portion Q will be described below with reference to FIG. 8. As shown in FIG. 6, each head unit Hn includes a plurality of nozzles Nz. Each nozzle Nz is a through-hole for ejecting ink in the Z2 direction. Specifically, each head unit Hn includes a plurality of nozzles Nz that eject the first ink and a plurality of nozzles Nz that eject the second ink. Additionally, each head unit Hn defines the in-head supply flow paths R1a and R1b and the in-head discharge flow paths R2a and R2b.

The in-head supply flow paths R1a and R1b are flow paths from an end portion of the head unit Hn in the Z1 direction to the liquid ejecting portion Q. The in-head discharge flow paths R2a and R2b are flow paths from the liquid ejecting portion Q to the end portion of the head unit Hn in the Z1 direction. The in-head supply flow paths R1a and R1b and the in-head discharge flow paths R2a and R2b are referred to as an in-head flow path Rn unless otherwise distinguished.

The head unit Hn includes a case 335 that defines the in-head flow path Rn.

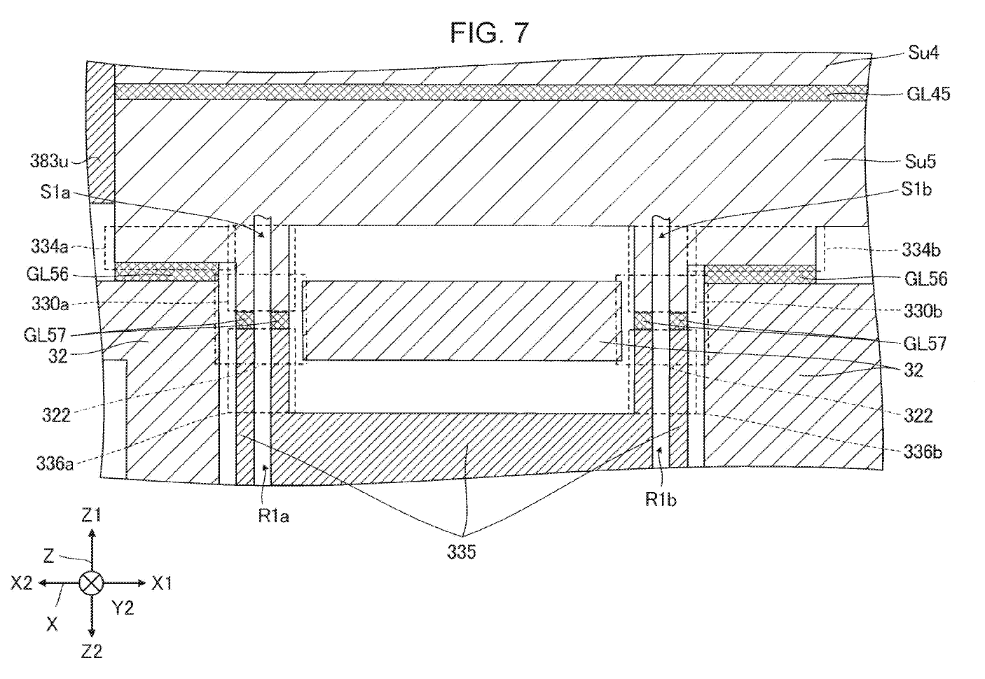

FIG. 7 is an enlarged view of a vicinity of the ink hole 322 shown in FIG. 6. The flow path plate Su5 includes columnar projecting portions 334a and 334b protruding in the Z2 direction. The projecting portions 334a and 334b are bonded in the Z1 direction to the holder member 32 by an adhesive forming the bonding portion GL56.

The flow path plate Su5 includes flow path plate side communication tubes 330a and 330b. The flow path plate side communication tubes 330a and 330b are collectively referred to as a flow path plate side communication tube 330. The flow path plate side communication tube 330 protrudes from the flow path plate Su5 toward the case 335 and is inserted through the ink hole 322.

The case 335 includes case side communication tubes 336a and 336b. The case side communication tubes 336a and 336b are collectively referred to as a case side communication tube 336. The case side communication tube 336 protrudes from the case 335 toward the flow path plate Su5 and is inserted through the ink hole 322.

An adhesive forming a bonding portion GL57 is applied to a top surface of the flow path plate side communication tube 330 and a top surface of the case side communication tube 336.

A flow direction of ink in the in-head supply flow paths R1a and R1b is the Z2 direction. The top surface of the flow path plate side communication tube 330 and the top surface of the case side communication tube 336 are perpendicular to the flow direction of ink.

The description returns to FIGS. 5 and 6. As shown in FIG. 5, the fixing plate 36 is a plate member for fixing the plurality of head units Hn to the holder member 32. The fixing plate 36 includes a plurality of opening portions 361 for exposing the nozzles Nz of the plurality of head units Hn.

The reinforcing plate 37 is disposed between the holder member 32 and the fixing plate 36 and is fixed to the fixing plate 36 by an adhesive. The reinforcing plate 37 includes a plurality of opening portions 371 in which the plurality of head units Hn are disposed.

The wiring substrate 381 is a mounting component for electrically coupling the liquid ejecting head 30 to the control circuit 21 shown in FIG. 4. The wiring substrate 381 is disposed on the laminate 333. The wiring member 382 is installed on the wiring substrate 381. The wiring member 382 is a member for electrically coupling the liquid ejecting head 30 and the control circuit 21. The wiring member 382 is, for example, a connector. The wiring member 382 may be, for example, a signal cable such as a flexible flat cable (FFC).

The circuit boards 383u and 383v are disposed to sandwich the laminate 333 and are electrically coupled to the wiring substrate 381. The flexible substrate 51 mounted on each of the head units H1 and H3 is electrically coupled to the circuit board 383u via a relay substrate (not shown). The flexible substrate 51 mounted on each of the head units H2 and H4 is electrically coupled to the circuit board 383v via a relay substrate (not shown).

### 1-6. Head Unit Hn

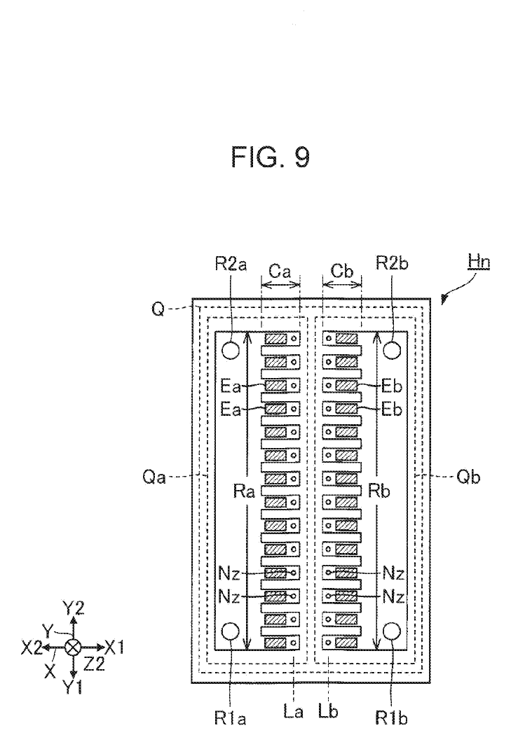

FIG. 8 is a cross-sectional view of the head unit Hn taken along the X-axis direction through the wiring hole 323. The view shown in FIG. 8 is a view of a cross-section of the head unit Hn taken along the X-axis direction through the wiring hole 323 as viewed in the Y2 direction. FIG. 9 is a plan view schematically showing the inside of the head unit Hn. The view shown in FIG. 9 is a plan view of the inside of the head unit Hn as viewed in the Z2 direction. In each of FIGS. 8 and 9, a portion of the head unit Hn shown in FIG. 6 in the vicinity of the fixing plate 36 is shown.

As shown in FIG. 8, the head unit Hn includes a nozzle plate 40, a communication plate 42, a pressure chamber substrate 43, a diaphragm 44, a plurality of drive elements E, a protection portion 46, a compliance substrate 45, and the case 335 mentioned above.

Each of the nozzle plate 40, the communication plate 42, the pressure chamber substrate 43, and the diaphragm 44 is an elongated plate-shaped member along the Y-axis. The pressure chamber substrate 43 and the case 335 are disposed in the Z1 direction with respect to the communication plate 42. On the other hand, the nozzle plate 40 and the compliance substrate 45 are disposed in the Z2 direction with respect to the communication plate 42. In addition, the members provided in the head unit Hn are joined to each other by an adhesive. Although not shown in FIG. 8, the layer formed by the adhesive joining the members provided in the head unit Hn to each other is also included in the bonding portion GL.

As shown in FIG. 9, the plurality of nozzles Nz are classified into a first nozzle row La and a second nozzle row Lb. Each of the first nozzle row La and the second nozzle row Lb is a group of a plurality of nozzles Nz arranged linearly along the Y-axis. The first nozzle row La and the second nozzle row Lb are spaced apart from each other and are arranged in the X-axis direction. Here, the liquid ejecting portion Q includes a first liquid ejecting portion Qa including a plurality of nozzles Nz belonging to the first nozzle row La, and a second liquid ejecting portion Qb including a plurality of nozzles Nz belonging to the second nozzle row Lb. The first liquid ejecting portion Qa ejects the first ink supplied from the sub tank 13a, from each nozzle Nz of the first nozzle row La. The second liquid ejecting portion Qb ejects the second ink supplied from the sub tank 13b, from each nozzle Nz of the second nozzle row Lb.

In the following description, a subscript "a" is added to reference numerals of elements related to the first nozzle row La, and a subscript "b" is added to reference numerals of elements related to the second nozzle row Lb. Additionally, elements related to the first liquid ejecting portion Qa and elements related to the second liquid ejecting portion Qb are disposed in a substantially plane-symmetrical structure. Accordingly, in the following description, elements corresponding to the first liquid ejecting portion Qa will be mainly described, and descriptions of elements corresponding to the second liquid ejecting portion Qb will be omitted as appropriate.

As shown in FIG. 8, the communication plate 42 is provided with the first communication flow path R3a and the second communication flow path R4a. Each of the first communication flow path R3a and the second communication flow path R4a is provided for each nozzle Nz. The nozzle Nz communicates with the pressure chamber Ca, which will be described below, through the first communication flow path R3a. The nozzle Nz communicates with the first liquid storage chamber Ra, which will be described below, through the second communication flow path R4a. Additionally, the compliance substrate 45 constitutes a part of a wall surface of the first liquid storage chamber Ra. The compliance substrate 45 includes, for example, a resin film 45a having flexibility and a metal plate 45b such as stainless steel.

The pressure chamber substrate 43 is provided with a plurality of pressure chambers Ca. The pressure chamber Ca is a space that communicates with the nozzle Nz via the first communication flow path R3a. The diaphragm 44 that is elastically deformable is disposed above the pressure chamber Ca. A part or all of the diaphragm 44 may be a separate member from the pressure chamber substrate 43 or may be integrated. In addition, a drive element Ea is formed for each pressure chamber Ca on a surface of the diaphragm 44 on a side opposite to the pressure chamber Ca. A plurality of drive elements Ea are disposed in one-to-one correspondence with the plurality of nozzles Nz. The drive element Ea generates energy for ejecting ink. Specifically, the drive element Ea ejects ink from the nozzle Nz by the application of the drive signal. For example, the drive element Ea is a piezoelectric element that changes the volume of the pressure chamber Ca.

The protection portion 46 is disposed above the diaphragm 44. In addition, the flexible substrate 51 is joined to a surface of the diaphragm 44. A plurality of wirings for electrically coupling the control circuit 21 and the head unit Hn are formed at the flexible substrate 51. Further, a drive circuit 50 that drives the drive element E is mounted on the flexible substrate 51. The drive circuit 50 selects whether or not to supply various signals, such as a drive signal for driving each drive element Ea, to each drive element Ea based on signals output from the control circuit 21.

The case 335 includes the first liquid storage chamber Ra for storing ink. Additionally, the case 335 includes a part of the in-head supply flow paths R1a and R1b and the in-head discharge flow paths R2a and R2b mentioned above. As shown in FIG. 8, each of the in-head supply flow path R1a and the in-head discharge flow path R2a is coupled to the first liquid storage chamber Ra. Further, as shown in FIG. 8, the case 335 includes a substrate hole 411 through which the flexible substrate 51 is inserted.

### 1-7. Shape of In-Structure Flow Path Sn

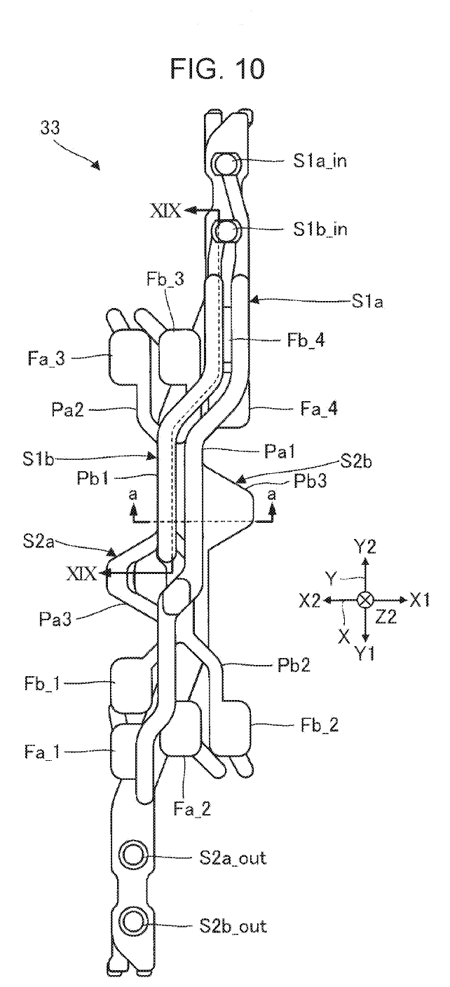

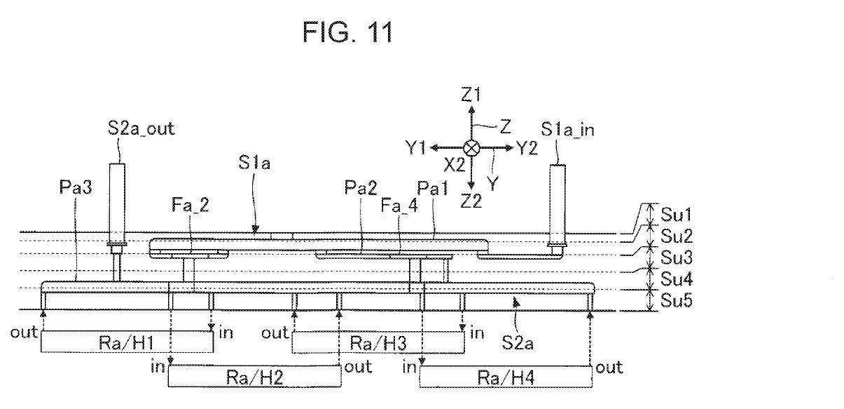

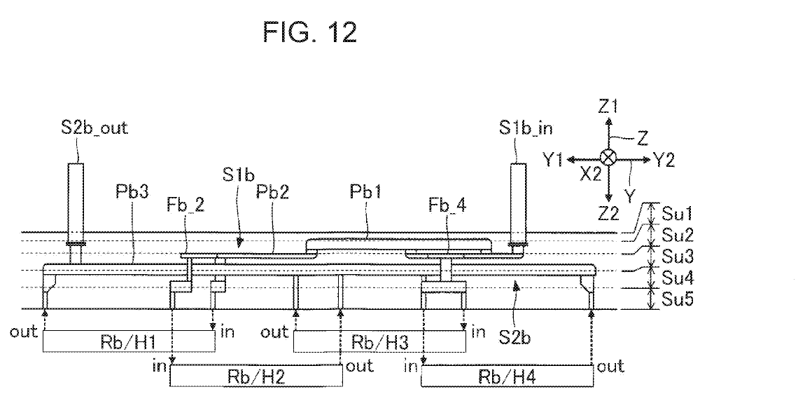

FIG. 10 is a plan view exemplifying the in-structure flow path Sn. FIG. 11 is a side view of the in-structure supply flow path S1a and the in-structure discharge flow path S2a of the in-structure flow path Sn, through which the first ink flows. FIG. 12 is a side view of the in-structure supply flow path S1b and the in-structure discharge flow path S2b of the in-structure flow path Sn, through which the second ink flows. In FIGS. 11 and 12, the first liquid storage chamber Ra of each head unit Hn is indicated by reference numeral "Ra/Hn", and the second liquid storage chamber Rb of each head unit Hn is indicated by reference numeral "Rb/Hn". The configuration of the in-structure flow path Sn is not limited to the following configuration.

As exemplified in FIGS. 10, 11, and 12, the flow path structure 33 is provided with the in-structure supply flow paths S1a and S1b and the in-structure discharge flow paths S2a and S2b. The in-structure supply flow path S1a is a flow path from the supply port S1a_in to the in-head supply flow path R1a of each head unit Hn, and the in-structure discharge flow path S2a is a flow path from the in-head discharge flow path R2a of each head unit Hn to the discharge port S2a_out. The in-structure supply flow path S1b is a flow path from the supply port S1b_in to the in-head supply flow path R1b of each head unit Hn, and the in-structure discharge flow path S2b is a flow path from the in-head discharge flow path R2b of each head unit Hn to the discharge port S2b_out.

As exemplified in FIGS. 10 and 11, the in-structure supply flow path S1a is a flow path including a supply portion Pa1, a coupling portion Pa2, and four filter portions Fa_1 to Fa_4. As exemplified in FIG. 11, the supply portion Pa1 is formed between the flow path plates Su1 and Su2. The supply portion Pa1 has a shape extending along the Y-axis. An end portion of the supply portion Pa1 in the Y2 direction communicates with the supply port S1a_in.

As exemplified in FIGS. 10 and 12, the in-structure supply flow path S1b is a flow path including a supply portion Pb1, a coupling portion Pb2, and four filter portions Fb_1 to Fb_4. As exemplified in FIG. 12, the supply portion Pb1 is formed between the flow path plates Su1 and Su2. The supply portion Pb1 has a shape extending along the Y-axis. An end portion of the supply portion Pb1 in the Y2 direction communicates with the supply port S1b_in.

The coupling portion Pa2 and the four filter portions Fa_1 to Fa_4 are formed between the flow path plates Su2 and Su3. The coupling portion Pa2 communicates with the supply portion Pa1 via a through-hole formed in the flow path plate Su2. The coupling portion Pa2 extends in the Y2 direction from a coupling position to the supply portion Pa1 and branches into two systems to communicate with the filter portions Fa_1 and Fa_3.

The filter portion Fa_2 communicates with the supply portion Pa1 via a through-hole formed in the flow path plate Su2. The filter portion Fa_4 communicates with the supply portion Pa1 via a through-hole formed in the flow path plate Su2. Each of the filter portions Fa_1 to Fa_4 communicates with the in-head supply flow path R1a of each head unit Hn via a through-hole penetrating through the flow path plates Su3 to Su5.

As exemplified in FIGS. 10 and 12, the in-structure supply flow path S1b is a flow path including a supply portion Pb1, a coupling portion Pb2, and four filter portions Fb_1 to Fb_4. The supply portion Pb1 is formed between the flow path plates Su1 and Su2. The supply portion Pb1 has a shape extending along the Y-axis. The supply port S1b_in communicates with an end of the supply portion Pb1 in the Y2 direction. Here, the supply portions Pa1 and Pb1 are provided in parallel between the flow path plates Su1 and Su2.

The coupling portion Pb2 and the four filter portions Fb_1 to Fb_4 are formed between the flow path plates Su2 and Su3. The coupling portion Pb2 communicates with the supply portion Pb1 via a through-hole formed in the flow path plate Su2. The coupling portion Pb2 extends in the Y1 direction from a coupling position to the supply portion Pb1 and branches into two systems to communicate with the filter portions Fb_2 and Fb_4. Here, the coupling portion Pb2 extends in a direction opposite to the coupling portion Pa2 from the coupling position to the supply portion Pb1.

The filter portion Fb_1 communicates with the supply portion Pb1 via a through-hole formed in the flow path plate Su2. The filter portion Fb_3 communicates with the supply portion Pb1 via a through-hole formed in the flow path plate Su2. Each of the filter portions Fb_1 to Fb_4 communicates with the in-head supply flow path R1b of each head unit Hn via a through-hole penetrating through the flow path plates Su3 to Su5.

As exemplified in FIGS. 10 and 11, the in-structure discharge flow path S2a is a flow path including a discharge portion Pa3. The discharge portion Pa3 is formed between the flow path plates Su4 and Su5. The discharge portion Pa3 has a shape that extends along the Y-axis over a wider range than the supply portion Pa1. A vicinity of an end portion of the discharge portion Pa3 in the Y1 direction communicates with the discharge port S2a_out. The in-head discharge flow path R2a of each head unit Hn communicates with the discharge portion Pa3 via a through-hole penetrating through the flow path plate Su5.

As exemplified in FIGS. 10 and 12, the in-structure discharge flow path S2b is a flow path including a discharge portion Pb3. The discharge portion Pb3 is formed between the flow path plates Su3 and Su4. The discharge portion Pb3 has a shape that extends along the Y-axis over a wider range than the supply portion Pb1. A vicinity of an end portion of the discharge portion Pb3 in the Y1 direction communicates with the discharge port S2b_out. The in-head discharge flow path R2b of each head unit Hn communicates with the discharge portion Pb3 via a through-hole penetrating through the flow path plates Su4 and Su5.

### 1-8. Mechanism for Detecting Sign of Ink Leakage from Liquid Ejecting Head 30

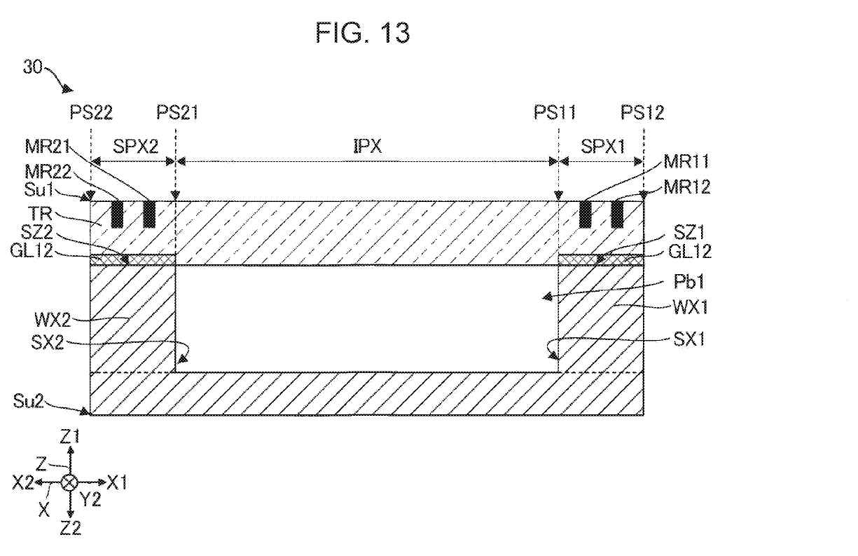

In the present embodiment, in order to detect a sign of ink leakage from the flow path of the liquid ejecting head 30 to the outside, a light-transmitting portion TR having light-transmitting properties is provided in the vicinity of the bonding portion GL that bonds the two flow path members, for confirming the degree of deterioration of the bonding portion GL. A set of two flow path members is two members constituting the liquid ejecting head 30 and need only be two members constituting a part of the flow path SF and bonded using some kind of adhesive. Specifically, the set of two flow path members is a set of two adjacent flow path plates Su in the flow path structure 33 and a set of the flow path plate Su5 and the case 335, and is a set of two members constituting the head unit Hn, constituting a part of the flow path SF, and bonded using some kind of adhesive. The set of two members in the head unit Hn is specifically a set of the case 335 and the communication plate 42, a set of the communication plate 42 and the pressure chamber substrate 43, a set of the communication plate 42 and the compliance substrate 45, a set of the communication plate 42 and the nozzle plate 40, and a set of the pressure chamber substrate 43 and the diaphragm 44. However, in the present embodiment, in order for the user U to visually confirm the degree of deterioration, it is preferable that the light-transmitting portion TR is provided at a position easily visually recognizable from the outside of the liquid ejecting head 30, specifically, in a set of two flow path members of the liquid ejecting head 30 other than the head unit Hn. The light-transmitting portion TR will be described with reference to FIG. 13.

FIG. 13 is a view illustrating the light-transmitting portion TR. FIG. 13 shows an example in which the light-transmitting portion TR having light-transmitting properties is provided in the vicinity of the supply portion Pb1 of the in-structure supply flow path S1b. In the following drawings, the configurations of the supply portion Pb1 and the like are shown in a simplified manner. FIG. 13 shows the vicinity of the supply portion Pb1 in a cross-section of the liquid ejecting head 30 taken along line a-a shown in FIG. 10. As understood from FIG. 13, in the first embodiment, a surface of the flow path plate Su2 that faces the Z1 direction is recessed in the Z2 direction, so that an end of the supply portion Pb1 in the X1 direction, an end of the supply portion Pb1 in the X2 direction, and an end of the supply portion Pb1 in the Z2 direction are defined. In the first embodiment, the flow path plate Su1 is an example of a "first flow path member", the flow path plate Su2 is an example of a "second flow path member", and the bonding portion GL12 is an example of a "first bonding portion". The supply portion Pb1 of the in-structure supply flow path S1b is an example of a "flow path". The nozzle Nz communicating with the supply portion Pb1 is an example of a "nozzle".

The flow path plate Su1 includes the light-transmitting portion TR having light-transmitting properties. Having light-transmitting properties means that a member having a thickness of 10 mm or less has a visible light transmittance of 50% or greater. However, in order to visually recognize the bonding portion GL12 via the light-transmitting portion TR, it is preferable that the transmittance is high, and specifically, it is preferable that a member having a thickness of 10 mm or less has a visible light transmittance of 70% or greater, and more preferably 90% or greater. The member having light-transmitting properties is formed of glass and transparent resin materials such as a transparent epoxy resin and a transparent acrylic resin. Additionally, although not shown, a width of the light-transmitting portion TR in the direction along the Y-axis may coincide with a length of the supply portion Pb1 in the direction along the Y-axis in plan view, or may be shorter than the length of the supply portion Pb1 in the direction along the Y-axis. As a method of manufacturing the flow path plate Su1, for example, the light-transmitting portion TR and a non-light-transmitting resin may be integrated by insert molding, or the light-transmitting portion TR may be bonded to the non-light-transmitting resin using some kind of adhesive.

The flow path plate Su1 is positioned in the Z1 direction with respect to a center C1 of the liquid ejecting head 30 in the Z-axis shown in FIG. 6. The center C1 is a midpoint between an end of the liquid ejecting head 30 in the Z1 direction and an end of the liquid ejecting head 30 in the Z2 direction. In addition, the flow path plate Su1 defines an end surface of the flow path structure 33 in the direction along the Z-axis. The Z1 direction is an example of a "direction opposite to an ejection direction".

As understood from FIG. 13, in plan view, the light-transmitting portion TR is classified into an overlapping region SPX1 that overlaps a partition wall WX1, an overlapping region SPX2 that overlaps a partition wall WX2, and a non-overlapping region IPX that does not overlap either of the partition walls WX1 and WX2. The non-overlapping region IPX can also be said to be a region that overlaps the supply portion Pb1 in plan view. The partition wall WX1 is a partition wall of the flow path plate Su2 that defines the end of the supply portion Pb1 in the X1 direction. The partition wall WX2 is a partition wall of the flow path plate Su2 that defines the end in the X2 direction. The plan view is an example of "viewed in a lamination direction of the first flow path member and the second flow path member".

In order to directly confirm the degree of deterioration of the bonding portion GL12, the light-transmitting portion TR is preferably configured such that the bonding portion GL12 can be visually recognized from the outside of the flow path structure 33. Specifically, the overlapping region SPX1 is bonded by the bonding portion GL12 to a surface SZ1 of the partition wall WX1 that faces the Z1 direction. The overlapping region SPX2 is bonded by the bonding portion GL12 to a surface SZ2 of the partition wall WX2 that faces the Z1 direction.

The light-transmitting portion TR has a mark used as a scale for indicating the degree of deterioration of the bonding portion GL12. Specifically, the overlapping region SPX1 has a first scale mark MR11 and a second scale mark MR12 between a first position PS11, which is an end that defines the supply portion Pb1 among both ends of the overlapping region SPX1 along the X-axis, and a second position PS12, which is an end that does not define the supply portion Pb1. The first position PS11 is a position of a wall surface SX1 of the partition wall WX1 that faces the X2 direction, in the direction along the X-axis. The second scale mark MR12 is positioned between the second position PS12 and the first scale mark MR11. Similarly, the overlapping region SPX2 has a first scale mark MR21 and a second scale mark MR22 between a first position PS21, which is an end that defines the supply portion Pb1 among both ends of the overlapping region SPX2 along the X-axis, and a second position PS22, which is an end that does not define the supply portion Pb1. The first position PS21 is a position of a wall surface SX2 of the partition wall WX2 that faces the X1 direction, in the direction along the X-axis. The second scale mark MR22 is positioned between the second position PS22 and the first scale mark MR21. In the following description, the first scale mark MR11, the second scale mark MR12, the first scale mark MR21, and the second scale mark MR12 may be collectively referred to as a "scale mark". The first scale mark MR11 and the first scale mark MR21 are examples of a "first mark", and the second scale mark MR12 and the second scale mark MR22 are examples of a "second mark".

When the light-transmitting portion TR is formed of glass or a transparent resin material, the scale mark can be formed by, for example, laser etching. The scale mark may be a dot having a size that can be visually recognized from the outside of the flow path structure 33, or may be, for example, a line segment having a thickness that can be visually recognized from the outside of the flow path structure 33 along an extending direction of the supply portion Pb1. The line segment along the extending direction of the supply portion Pb1 may be a solid line or a broken line.

The interval between the scale marks may be equal or unequal. When the scale marks are at equal intervals, a shortest distance from the first position PS11 to the first scale mark MR11, a shortest distance from the first scale mark MR11 to the second scale mark MR12, and a distance from the second scale mark MR12 to the second position PS12 are substantially equal.

In order to make the degree of deterioration of the bonding portion GL12 more easily visually recognized, the bonding portion GL12 may have a property of discoloring upon contact with ink in the supply portion Pb1. A discoloration aspect in which discoloration occurs upon contact with ink has the following two aspects. A first discoloration aspect is an aspect in which a colorant of the adhesive changes upon contact with ink. For example, the adhesive forming the bonding portion GL12 contains an anthocyanin colorant. The color of the anthocyanin colorant is red in an acidic state and blue in an alkaline state. Therefore, in the first discoloration aspect, at a time point of manufacturing the liquid ejecting head 30, when the liquid property of the ink is acidic, the head manufacturer forms the bonding portion GL12 such that the bonding portion GL12 becomes alkaline. On the other hand, when the liquid property of the ink is alkaline, the bonding portion GL12 is formed such that the bonding portion GL12 becomes acidic. As a result, since the anthocyanin colorant discolors when the bonding portion GL12 comes into contact with ink, the bonding portion GL12 has a property of discoloring upon contact with ink. A colorant that discolors depending on the liquid property is not limited to an anthocyanin colorant, and may be a flavonoid colorant.

A second discoloration aspect is an aspect in which the bonding portion GL12 is transparent or translucent, and the bonding portion GL12 discolors because of a color material contained in ink when the ink containing the color material penetrates into the bonding portion GL12.

It is preferable that a rate at which the bonding portion GL12 discolors upon contact with ink in the supply portion Pb1 is such that the bonding portion GL12 gradually discolors upon contact with the ink.

However, the bonding portion GL12 need not discolor even upon contact with the ink. Even when the bonding portion GL12 does not discolor, the user U may decide on the replacement timing of the liquid ejecting head 30 based on disappearance of a trace of the bonding portion GL12.

In order for the user U to visually recognize the bonding portion GL12, a through-hole or a transparent member is provided in a portion of a partition wall of the cover member 31 in the Z1 direction that overlaps the bonding portion GL12 as viewed in the direction along the Z-axis, and the bonding portion GL12 can be visually recognized from the outside of the liquid ejecting head 30 via the light-transmitting portion TR.

### 1-9. Summary of First Embodiment

As described above, in the first embodiment, the liquid ejecting head 30 includes the nozzle Nz that ejects ink, the flow path plates Su1 and Su2 that constitute the supply portion Pb1 communicating with the nozzle Nz, and the bonding portion GL12 that liquid-tightly couples the flow path plates Su1 and Su2 to constitute the supply portion Pb1. The flow path plate Su1 includes the light-transmitting portion TR having light-transmitting properties for confirming the degree of deterioration of the bonding portion GL12 from the outside of the flow path plate Su1.

According to the first embodiment, since the user U can confirm the state of the bonding portion GL12 through the light-transmitting portion TR, the user U can confirm the degree of deterioration of the bonding portion GL12. The user U can know a time point at which deterioration of the bonding portion GL12 is detected as an appropriate timing for replacing the liquid ejecting head 30. In addition, the liquid ejecting head 30 can be replaced at an appropriate timing by confirming the degree of deterioration of the bonding portion GL12. Further, according to the present embodiment, it is possible to detect a sign of ink leakage from the liquid ejecting head 30 without destroying the liquid ejecting head 30.

In addition, the light-transmitting portion TR includes a portion that is bonded to the bonding portion GL12, specifically, the overlapping region SPX1 and the overlapping region SPX2.

According to the first embodiment, since it is possible to directly confirm the state of the deteriorating bonding portion GL12 that is deteriorated with use of the liquid ejecting head 30 through the overlapping regions SPX1 and SPX2, the liquid ejecting head 30 can be replaced at an appropriate timing.

In addition, as viewed in the Z2 direction, which is the lamination direction of the flow path plates Su1 and Su2, the light-transmitting portion TR has the first scale mark MR11 between the first position PS11, which is a position of the end of the bonding portion GL12 that defines the flow path, and the second position PS12, which is a position of the end of the bonding portion GL12 that does not define the flow path.

As deterioration of the bonding portion GL12 progresses, the end of the bonding portion GL12 that defines the flow path gradually approaches the second position PS12. Therefore, when the end of the bonding portion GL12 that defines the flow path overlaps the first scale mark MR11, it can be known that it is a replacement timing of the liquid ejecting head 30. As described above, according to the first embodiment, the user U can know a guideline for the replacement timing of the liquid ejecting head 30 using the first scale mark MR11.

Additionally, as viewed in the Z2 direction, the light-transmitting portion TR has a second scale mark MR12 between the second position PS12 and the first scale mark MR11.

According to the first embodiment, the user U can know the lifetime of the liquid ejecting head 30 in stages. Specifically, the user U can use the liquid ejecting head 30 until immediately before the liquid ejecting head 30 fails, based on the second scale mark MR12, while securing a period of time for preparing a replacement liquid ejecting head 30 based on the first scale mark MR11. For example, when the end of the bonding portion GL12 that defines the flow path overlaps the first scale mark MR11, the user U orders the liquid ejecting head 30 from the head manufacturer. Then, when the end of the bonding portion GL12 that defines the flow path overlaps the second scale mark MR12, the user U replaces the liquid ejecting head 30 with a new liquid ejecting head 30 acquired from the head manufacturer. In the first embodiment, the light-transmitting portion TR has the second scale mark MR12, but need not have the second scale mark MR12.

Further, the bonding portion GL12 may have a property of discoloring upon contact with the ink in the supply portion Pb1.

According to the first embodiment, the user U can easily confirm the degree of deterioration of the bonding portion GL12 as compared with an aspect in which the bonding portion GL12 does not have a property of discoloring upon contact with the ink in the supply portion Pb1.

In addition, the flow path plate Su1 is positioned in the Z1 direction with respect to the center C1 of the liquid ejecting head 30 in the Z-axis along the Z2 direction, which is the ejection direction in which the nozzle Nz ejects ink.

The support 241 is present in the Z2 direction with respect to the flange portion 324 of the liquid ejecting head 30. In an aspect in which the flow path plate Su1 including the light-transmitting portion TR is positioned in the Z2 direction with respect to the center C1, the user U may not visually recognize the light-transmitting portion TR unless the liquid ejecting head 30 is removed from the support 241. Accordingly, according to the first embodiment, as compared with an aspect in which the flow path plate Su1 is positioned in the Z2 direction with respect to the center C1, it becomes easier to confirm the degree of deterioration of the bonding portion GL12.

Additionally, the liquid ejecting head 30 includes the laminate 333 in which the plurality of flow path plates Su defining the supply portion Pb1 and including the flow path plates Su1 and Su2 are laminated in the direction along the Z-axis, and the flow path plate Su1 defines the end surface of the laminate 333 in the direction along the Z-axis.

In an aspect in which the flow path plate Su1 including the light-transmitting portion TR does not define the end surface of the laminate 333 in the direction along the Z-axis, the bonding portion GL12 needs to be visually recognized from the direction perpendicular to the Z-axis. As understood from FIG. 13, since the bonding portion GL12 is provided along the X-Y plane, it is difficult to confirm the degree of deterioration of the bonding portion GL12 from the direction perpendicular to the Z-axis. Therefore, according to the first embodiment, as compared with an aspect in which the flow path plate Su1 does not define the end surface of the laminate 333 in the direction along the Z-axis, it becomes easier to confirm the degree of deterioration of the bonding portion GL12.

### 2. Second Embodiment

In a second embodiment, the flow path plates Su include a dummy bonding portion GLD provided only for confirming the degree of deterioration of the bonding portion GL12 without bonding the two flow path plates Su.

### 2-1. Light-Transmitting Portion TRa in Second Embodiment

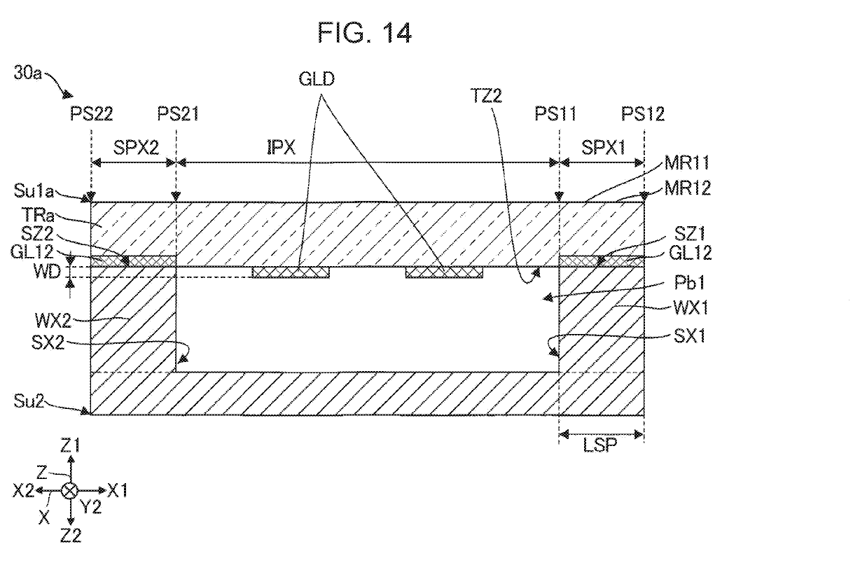

FIG. 14 is a view illustrating a light-transmitting portion TRa in the second embodiment. A liquid ejecting head 30a in the second embodiment includes a flow path plate Su1a instead of the flow path plate Su1. The flow path plate Su1a includes the light-transmitting portion TRa instead of the light-transmitting portion TR. The dummy bonding portion GLD is bonded to the light-transmitting portion TRa. The dummy bonding portion GLD is an example of a "second bonding portion".

The light-transmitting portion TRa includes a surface TZ2 of the flow path plate Su1a that defines the supply portion Pb1. The dummy bonding portion GLD is bonded to the surface TZ2. In the example of FIG. 14, the dummy bonding portion GLD is bonded to the surface TZ2 to cover a part of the surface TZ2. In plan view, a ratio of an area of the dummy bonding portion GLD to an area of the surface TZ2 is preferably 50% or less, and more preferably 30% or less. In the example of FIG. 14, two dummy bonding portions GLD are bonded to the surface TZ2. The number of the dummy bonding portions GLD may be one, or three or more. When two or more dummy bonding portions GLD are bonded to the surface TZ2, the ratio of the area of the dummy bonding portion GLD to the area of the surface TZ2 is a ratio of the total area of all the dummy bonding portions GLD bonded to the surface TZ2 to the area of the surface TZ2. As understood from FIG. 14, the dummy bonding portion GLD is provided not for the purpose of bonding the two flow path plates Su, but for directly confirming the degree of deterioration of the dummy bonding portion GLD from the outside of the flow path structure 33.

A thickness WD of the dummy bonding portion GLD in the direction along the Z-axis is shorter than a distance LSP. The distance LSP is a minimum distance from the first position PS11 to the second position PS12.

The bonding portion GL12 and the dummy bonding portion GLD may be formed of the same type of adhesive or may be formed of mutually different types of adhesives. Mutually different types of adhesives have the following two aspects. Hereinafter, a first aspect may be referred to as a "first aspect relating to an adhesive", and a second aspect may be referred to as a "second aspect relating to an adhesive".

In the first aspect relating to the adhesive, the liquid resistance of the dummy bonding portion GLD is lower than the liquid resistance of the bonding portion GL12. However, it is preferable that the liquid resistance of the dummy bonding portion GLD is slightly lower than the liquid resistance of the bonding portion GL12. For example, by changing a ratio of a main agent to a curing agent of the dummy bonding portion GLD with respect to a ratio of a main agent to a curing agent of the bonding portion GL12, it is possible to create the dummy bonding portion GLD with slightly weakened liquid resistance.

In the second aspect relating to the adhesive, the dummy bonding portion GLD has a property of discoloring upon contact with the ink in the supply portion Pb1, and the bonding portion GL12 does not have a property of discoloring upon contact with the ink in the supply portion Pb1. The discoloration property of the dummy bonding portion GLD may be the first discoloration aspect or the second discoloration aspect mentioned above.

Similarly to the first embodiment, in order for the user U to visually recognize the dummy bonding portion GLD, a through-hole or a transparent member is provided in a portion of the partition wall of the cover member 31 in the Z1 direction that overlaps the dummy bonding portion GLD as viewed in the direction along the Z-axis, and the dummy bonding portion GLD can be visually recognized from the outside of the liquid ejecting head 30a via the light-transmitting portion TRa.

### 2-2. Summary of Second Embodiment

As described above, in the liquid ejecting head 30a in the second embodiment, the light-transmitting portion TRa includes the surface TZ2 of the flow path plate Su1a that defines the supply portion Pb1, and the dummy bonding portion GLD is bonded to the surface TZ2.

According to the second embodiment, the user U can indirectly confirm a deterioration state of the bonding portion GL12 by confirming a remaining state of the dummy bonding portion GLD. In addition, in the first embodiment, it is necessary to provide a through-hole or a transparent member only at a portion of the partition wall of the cover member 31 in the Z1 direction where the flow path plate Su1 is bonded. On the other hand, in the second embodiment, since the through-hole or the transparent member can be provided at other portions than a portion of the partition wall of the cover member 31 in the Z1 direction where the flow path plate Su1a and the flow path plate Su2 are bonded, the degree of freedom in designing the liquid ejecting head 30a can be improved.

Additionally, in the initial state of the liquid ejecting head 30a, the dummy bonding portion GLD is disposed to cover a part of the surface TZ2.

According to the second embodiment, by confirming whether or not the dummy bonding portion GLD is present, it is possible to indirectly confirm the deterioration state of the bonding portion GL12.

Further, the bonding portion GL12 and the dummy bonding portion GLD may be formed of the same type of adhesive.

Since the adhesive forming the bonding portion GL12 and the adhesive forming the dummy bonding portion GLD are of the same type, it is possible to make deterioration conditions of the bonding portion GL12 and the dummy bonding portion GLD the same for various inks. As a result of being able to make the deterioration conditions the same, in the second embodiment, it can be said that, as compared with an aspect in which the adhesives are of different types from each other, degrees of progression of deterioration of the bonding portion GL12 and the dummy bonding portion GLD upon contact with ink are close to each other. Therefore, when the dummy bonding portion GLD is deteriorated, the bonding portion GL12 is also highly likely to be deteriorated. As described above, according to the second embodiment, the bonding portion GL12 and the dummy bonding portion GLD are formed of the same type of adhesive, so that the estimation accuracy of the deterioration state of the bonding portion GL12 can be improved.

In addition, the thickness WD of the dummy bonding portion GLD is shorter than the distance LSP.

As mentioned above, it is necessary to detect a sign of ink leakage from the liquid ejecting head 30a before ink leaks from the liquid ejecting head 30a. Therefore, from the viewpoint of detecting a sign of ink leakage, a timing at which the dummy bonding portion GLD disappears from the surface TZ2 needs to be earlier than a timing at which ink leaks from the bonding portion GL12. In an aspect in which the bonding portion GL12 and the dummy bonding portion GLD are formed of the same type of adhesive and the thickness WD is longer than the distance LSP, even though a length of ink penetration into the bonding portion GL12 and a length of ink penetration into the dummy bonding portion GLD are equal, ink may leak from the bonding portion GL12 before the dummy bonding portion GLD disappears from the surface TZ2, because the distance LSP is shorter than the thickness WD. As described above, according to the second embodiment, since the dummy bonding portion GLD disappears from the surface TZ2 before the ink leaks from the bonding portion GL12, a sign of ink leakage from the liquid ejecting head 30a can be detected before the ink leaks from the liquid ejecting head 30a.

Additionally, in the first aspect relating to the adhesive, the liquid resistance of the dummy bonding portion GLD is lower than the liquid resistance of the bonding portion GL12.

As mentioned above, a timing at which the dummy bonding portion GLD disappears from the surface TZ2 needs to be earlier than a timing at which the ink leaks from the bonding portion GL12. Since the liquid resistance of the dummy bonding portion GLD is lower than the liquid resistance of the bonding portion GL12, the timing at which the dummy bonding portion GLD disappears from the surface TZ2 can be set earlier than the timing at which the ink leaks from the bonding portion GL12. Therefore, according to the second embodiment, it is possible to detect a sign of ink leakage from the liquid ejecting head 30a before the ink leaks from the liquid ejecting head 30a.

Further, in the second aspect relating to the adhesive, the dummy bonding portion GLD has a property of discoloring upon contact with the ink in the supply portion Pb1.

According to the second embodiment, as compared with an aspect in which the dummy bonding portion GLD does not discolor even upon contact with the ink in the supply portion Pb1, the user U can easily confirm the degree of deterioration of the bonding portion GL12.

### 3. Modification Example

Each of the aspects exemplified above can be variously modified. Specific modification aspects that can be applied to each of the aspects mentioned above will be exemplified below. Two or more aspects optionally selected from the following examples can be combined as appropriate within a range in which the aspects are not mutually contradictory.

### 3-1. First Modification Example

In the first embodiment, the partition wall WX1 that defines the end of the supply portion Pb1 in the X1 direction and the partition wall WX2 that defines the end of the supply portion Pb1 in the X2 direction are a part of the flow path plate Su2, but the present disclosure is not limited thereto.

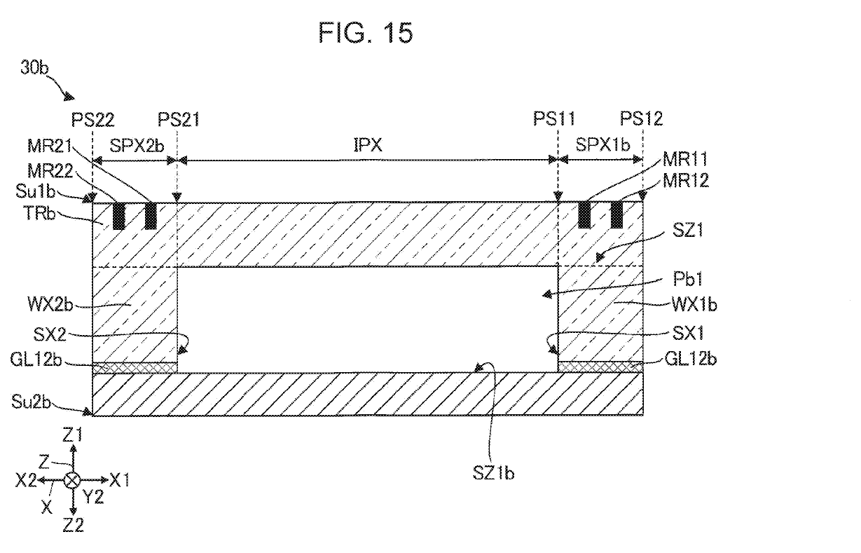

FIG. 15 is a view illustrating a light-transmitting portion TRb in a first modification example. A liquid ejecting head 30b in the first modification example includes a flow path plate Su1b instead of the flow path plate Su1, and includes a flow path plate Su2b instead of the flow path plate Su2. FIG. 15 shows the vicinity of the supply portion Pb1 in a cross-section of the liquid ejecting head 30b taken along line a-a shown in FIG. 10. As understood from FIG. 15, in the first modification example, the surface of the flow path plate Su1b that faces the Z2 direction is recessed in the Z1 direction, so that the end of the supply portion Pb1 in the X1 direction, the end in the X2 direction, and the end in the Z1 direction are defined.

The flow path plate Su1b includes the light-transmitting portion TRb instead of the light-transmitting portion TR. As understood from FIG. 15, in plan view, the light-transmitting portion TRb includes an overlapping region SPX1b instead of the overlapping region SPX1, and includes an overlapping region SPX2b instead of the overlapping region SPX2. The overlapping region SPX1b overlaps a partition wall WX1b of the flow path plate Su1b that defines the end of the supply portion Pb1 in the X1 direction in plan view. The overlapping region SPX2b overlaps a partition wall WX2b of the flow path plate Su1b that defines the end of the supply portion Pb1 in the X2 direction in plan view. The overlapping region SPX1b is bonded by a bonding portion GL12b in the first modification example to a surface SZ1b of the flow path plate Su2b that faces the Z1 direction. The overlapping region SPX2 is bonded to the surface SZ1b by the bonding portion GL12b.

In FIG. 15, the first modification example based on the first embodiment is shown, but the first modification example can also be applied to the second embodiment. Similarly, a second modification example, a third modification example, and a fifth modification example, which will be described below, can also be applied to the second embodiment.

### 3-2. Second Modification Example

In the first modification example, all of the partition wall WX1b that defines the end of the supply portion Pb1 in the X1 direction and the partition wall WX2b that defines the end of the supply portion Pb1 in the X2 direction are a part of the flow path plate Su1b, but the present disclosure is not limited thereto.

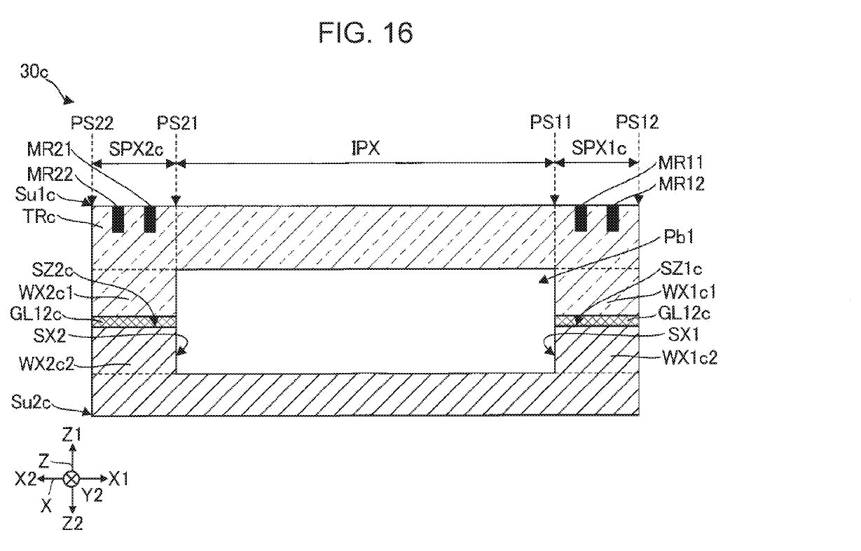

FIG. 16 is a view illustrating a light-transmitting portion TRc in the second modification example. A liquid ejecting head 30c in the second modification example includes a flow path plate Su1c instead of the flow path plate Su1, and includes a flow path plate Su2c instead of the flow path plate Su2. FIG. 16 shows the vicinity of the supply portion Pb1 in a cross-section of the liquid ejecting head 30c taken along line a-a shown in FIG. 10. As understood from FIG. 16, in the second modification example, a surface of the flow path plate Su1c that faces the Z2 direction is recessed in the Z1 direction, a surface of the flow path plate Su2c that faces the Z1 direction is recessed in the Z2 direction, and the two recessed spaces communicate to form the supply portion Pb1.

The flow path plate Su1c includes the light-transmitting portion TRc instead of the light-transmitting portion TR. As understood from FIG. 16, in plan view, the light-transmitting portion TRc includes an overlapping region SPX1c instead of the overlapping region SPX1, and includes an overlapping region SPX2c instead of the overlapping region SPX2. The overlapping region SPX1c overlaps a partition wall WX1c1 of the flow path plate Su1c that defines the end of the supply portion Pb1 in the X1 direction and a partition wall WX1c2 of the flow path plate Su2c that defines the end of the supply portion Pb1 in the X1 direction, in plan view. The overlapping region SPX2c overlaps a partition wall WX2c1 of the flow path plate Su1c that defines the end of the supply portion Pb1 in the X2 direction and a partition wall WX2c2 of the flow path plate Su2c that defines the end of the supply portion Pb1 in the X2 direction, in plan view.

The overlapping region SPX1c is bonded by a bonding portion GL12c in the second modification example to a surface SZ1c of the partition wall WX1c2 of the flow path plate Su2c that faces the Z1 direction. The overlapping region SPX2c is bonded by the bonding portion GL12c in the second modification example to a surface SZ2c of the partition wall WX2c2 of the flow path plate Su2c that faces the Z1 direction.

### 3-3. Third Modification Example

The bonding portion GL12 in each of the aspects mentioned above extends in the direction perpendicular to the Z-axis, but may extend in a direction parallel to the Z-axis.

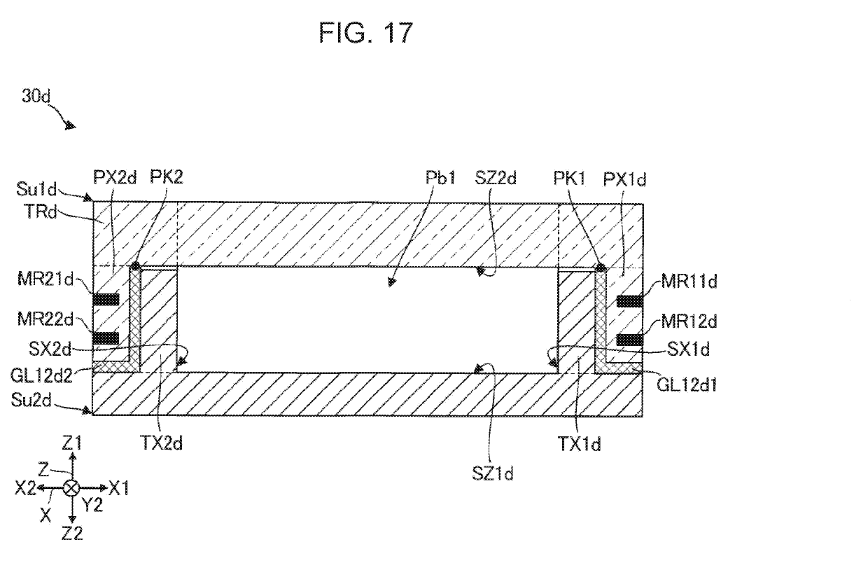

FIG. 17 is a view illustrating a light-transmitting portion TRd in a third modification example. A liquid ejecting head 30d in the third modification example includes a flow path plate Su1d instead of the flow path plate Su1, and includes a flow path plate Su2d instead of the flow path plate Su2. FIG. 17 shows the vicinity of the supply portion Pb1 in a cross-section of the liquid ejecting head 30d taken along line a-a shown in FIG. 10. As understood from FIG. 17, in the third modification example, the supply portion Pb1 is defined by a wall surface SX1d of a lower protruding portion TX1d that faces the X2 direction, a wall surface SX2d of a lower protruding portion TX2d that faces the X1 direction, a surface SZ1d of the flow path plate Su2d that faces the Z1 direction, and a surface SZ2d of the flow path plate Su1d that faces the Z2 direction. The lower protruding portion TX1d and the lower protruding portion TX2d protrude from the flow path plate Su2d in the Z1 direction.

As shown in FIG. 17, the flow path plate Su1d is provided with upper protruding portions PX1d and PX2d protruding in the Z2 direction. In the third modification example, the flow path plates Su1d and Su2d are bonded by bonding portions GL12d1 and GL12d2 instead of the bonding portion GL12. The bonding portions GL12d1 and GL12d2 may be collectively referred to as a bonding portion GL12d.

The bonding portion GL12d1 bonds the upper protruding portion PX1d and the lower protruding portion TX1d. Additionally, the bonding portion GL12d1 bonds a surface of the upper protruding portion PX1d that faces the Z2 direction and a region of the surface SZ1d that is positioned in the X1 direction with respect to the supply portion Pb1 in plan view. Ink penetrates into the bonding portion GL12d1 from a point PK1 on a base side of the upper protruding portion PX1d. The bonding portion GL12d2 bonds the upper protruding portion PX2d and the lower protruding portion TX2d. Further, the bonding portion GL12d2 bonds a surface of the upper protruding portion PX2d that faces the Z2 direction and a region of the surface SZ1d that is positioned in the X2 direction with respect to the supply portion Pb1 in plan view. Ink penetrates into the bonding portion GL12d2 from a point PK2 on a base side of the upper protruding portion PX2d.

As viewed in the direction along the X-axis, the upper protruding portion PX1d overlaps the lower protruding portion TX1d, and the upper protruding portion PX2d overlaps the lower protruding portion TX2d. The upper protruding portion PX1d is provided with a first scale mark MR11d and a second scale mark MR12d. As viewed in the direction along the X-axis, the first scale mark MR11d is positioned between the point PK1 and the second scale mark MR12d. In addition, the upper protruding portion PX2d is provided with a first scale mark MR21d and a second scale mark MR22d. As viewed in the direction along the X-axis, the first scale mark MR21d is positioned between the point PK2 and the second scale mark MR22d.

Similarly to the first embodiment, in order for the user U to visually recognize the upper protruding portion PX1d and the upper protruding portion PX2d, a through-hole or a transparent member is provided at a portion of the partition wall of the cover member 31 in the third modification example in the direction along the X-axis that overlaps the upper protruding portion PX1d and the upper protruding portion PX2d as viewed in the direction along the X-axis.

### 3-4. Fourth Modification Example

In each of the aspects mentioned above, in plan view, the flow path plate Su1 includes the light-transmitting portion TR also in a portion overlapping the supply portion Pb1, but the present disclosure is not limited thereto.

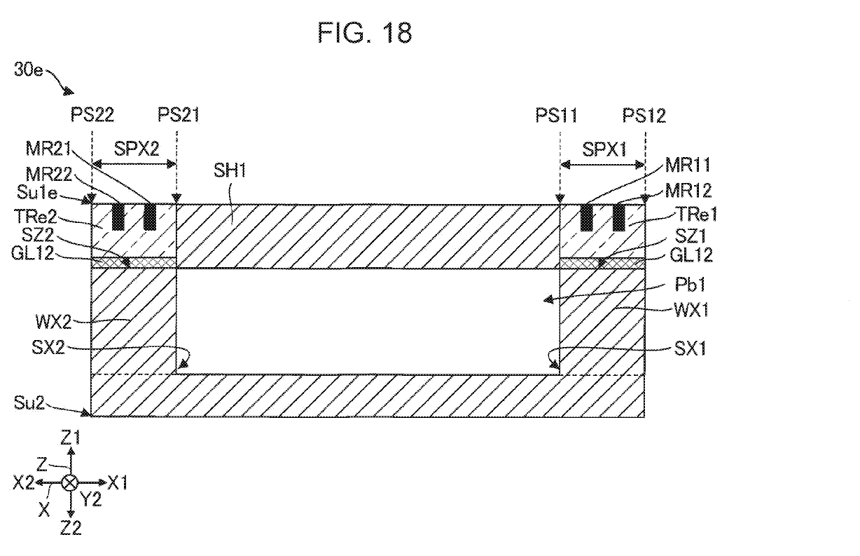

FIG. 18 is a view illustrating light-transmitting portions TRe1 and TRe2 in a fourth modification example. A liquid ejecting head 30e in the fourth modification example includes a flow path plate Su1e instead of the flow path plate Su1. FIG. 18 shows the vicinity of the supply portion Pb1 in a cross-section of the liquid ejecting head 30e taken along line a-a shown in FIG. 10.

The flow path plate Su1e includes a light-shielding portion SH1 and the light-transmitting portions TRe1 and TRe2 instead of the light-transmitting portion TR. In plan view, the light-shielding portion SH1 overlaps the supply portion Pb1, and the light-transmitting portion TRe1 and the light-transmitting portion TRe2 do not overlap the supply portion Pb1. The light-shielding portion SH1 does not transmit ultraviolet rays. By not transmitting ultraviolet rays, in the fourth modification example, it is possible to employ UV ink as the ink.

### 3-5. Fifth Modification Example

In each of the aspects mentioned above, the flow path plate Su1, which is an example of a "first flow path member", is provided with the light-transmitting portion TR, but the present disclosure is not limited thereto.

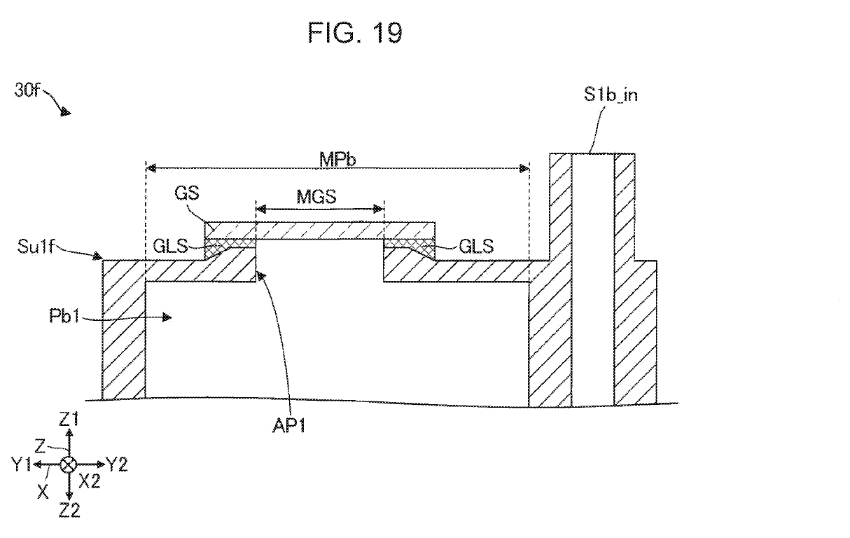

FIG. 19 is a view illustrating a light-transmitting portion in a fifth modification example. A liquid ejecting head 30f in the fifth modification example includes a flow path plate Su1f instead of the flow path plate Su1, and further includes a light-transmitting member GS. In the fifth modification example, the entirety of the light-transmitting member GS corresponds to a "light-transmitting portion". FIG. 19 shows a cross-section of the liquid ejecting head 30f taken along line XIX-XIX shown in FIG. 10 as viewed in the X2 direction.

As shown in FIG. 19, the flow path plate Su1f includes an opening portion AP1 that is open in the Z1 direction. The light-transmitting member GS is bonded to the flow path plate Su1f to cover the opening portion AP1 by a bonding portion GLS disposed around the opening portion AP1. As viewed in the Z2 direction, an area MGS of the opening portion AP1 is equal to or less than half of an area MPb defined by the flow path plate Su1f for the supply portion Pb1. Further, the light-transmitting member GS is smaller than the flow path plate Su1f as viewed in the Z2 direction. In the fifth modification example, the light-transmitting member GS is an example of a "first flow path member", the flow path plate Su1f is an example of a "second flow path member", the bonding portion GLS is an example of a "first bonding portion", the Z1 direction is an example of a "first direction", and the Z2 direction is an example of a "second direction".

The light-transmitting member GS is in a plate shape having a substantially constant thickness. In the present specification, a substantially constant plate-shaped member means that a shortest thickness with respect to a longest thickness is 0.8 or greater, and preferably 0.9 or greater. Similarly to the light-transmitting portion TR, the light-transmitting member GS is formed of glass and transparent resin materials such as a transparent epoxy resin and a transparent acrylic resin. However, when the light-transmitting member GS is formed of glass, it is easy to realize that the thickness is substantially constant.

As described above, in the fifth modification example, the flow path plate Su1f includes the opening portion AP1 that is open in the Z1 direction, the light-transmitting member GS is bonded to the flow path plate Su1f to cover the opening portion AP1 by the bonding portion GLS disposed around the opening portion AP1, the area MGS of the opening portion AP1 is equal to or less than half of the area MPb defined by the flow path plate Su1f for the supply portion Pb1 as viewed in the second direction opposite to the first direction, and the light-transmitting member GS is smaller than the flow path plate Su1f as viewed in the Z2 direction.

According to the fifth modification example, since it is easy to focus on a place to be observed through the light-transmitting member GS, the bonding portion GLS can be made easier to observe. In addition, since the light-transmitting member GS can be reduced in size, the manufacturing cost of the liquid ejecting head 30f can be reduced, and the liquid ejecting head 30f can also be made lighter. Further, since the shape of the flow path plate Su1f can be simplified, a material having a high liquid resistance such as glass can be employed as a "first flow path member".

The light-transmitting member GS is bonded to the flow path plate Su1f to cover the opening portion AP1 by the bonding portion GLS disposed around the opening portion AP1 of the flow path plate Su1f, and is in a plate shape having a substantially constant thickness.

According to the fifth modification example, the light-transmitting member GS can be easily formed of a material such as glass.

Although not shown, a scale mark may be provided in a portion that overlaps the light-transmitting member GS and the bonding portion GLS in plan view.

Additionally, in the fifth modification example, the Z1 direction is an example of a "first direction" and the Z2 direction is an example of a "second direction", but the present disclosure is not limited thereto. For example, the opening portion AP1 may be in a direction having a component in the Z1 direction. The direction having the component in the Z1 direction is, for example, a direction intersecting the Z-axis at an angle greater than 0 degrees and less than 90 degrees.

### 3-6. Sixth Modification Example

In the second embodiment, in the initial state of the liquid ejecting head 30a, the dummy bonding portion GLD is disposed to cover a part of the surface TZ2 of the light-transmitting portion TRa that defines the supply portion Pb1, but the dummy bonding portion GLD may be disposed to cover the entirety of the surface TZ2.

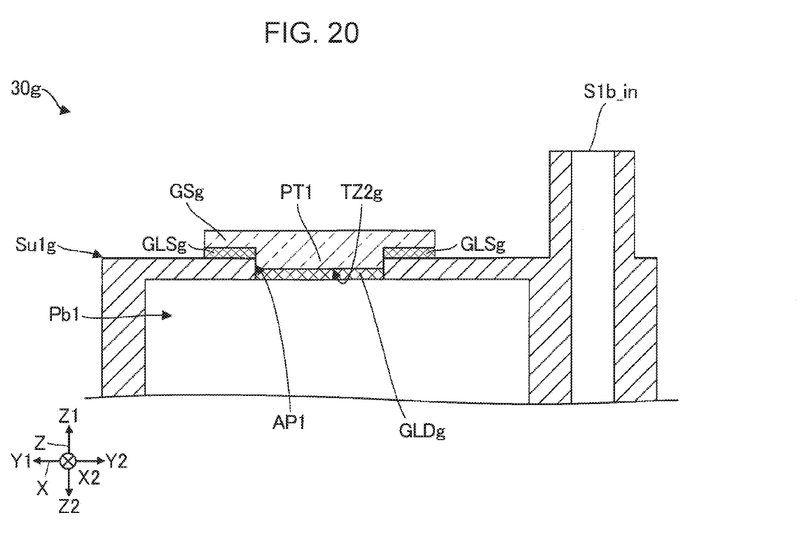

FIG. 20 is a view illustrating a light-transmitting portion in a sixth modification example. A liquid ejecting head 30g in the sixth modification example includes a flow path plate Su1g instead of the flow path plate Su1f, and includes a light-transmitting member GSg instead of the light-transmitting member GS. In the sixth modification example, the entirety of the light-transmitting member GSg corresponds to a "light-transmitting portion".

As shown in FIG. 20, the light-transmitting member GSg includes a protruding portion PT1 protruding in the Z2 direction. The light-transmitting member GSg is bonded to the flow path plate Su1g by a bonding portion GLSg disposed around the opening portion AP1 to cover the opening portion AP1. In plan view, the protruding portion PT1 is fitted into the opening portion AP1. Further, a surface TZ2g of the protruding portion PT1 in the Z2 direction defines the supply portion Pb1. A dummy bonding portion GLDg is disposed to cover the entirety of the surface TZ2g. In the sixth modification example, the bonding portion GLSg is an example of a "first bonding portion", the dummy bonding portion GLDg is an example of a "second bonding portion", and the surface TZ2g is an example of a "surface".

As described above, in the liquid ejecting head 30g in the sixth modification example, the dummy bonding portion GLDg is bonded to the surface TZ2g to cover the entirety of the surface TZ2g.

As described above, according to the sixth modification example, by confirming whether or not the dummy bonding portion GLDg is present, the deterioration state of the bonding portion GLSg can be indirectly confirmed.

What is claimed is:

1. A liquid ejecting head comprising:
a nozzle configured to eject liquid;
a first flow path member and a second flow path member that constitute a flow path communicating with the nozzle; and
a first bonding portion that liquid-tightly couples the first flow path member and the second flow path member to constitute the flow path, wherein
the first flow path member includes a light-transmitting portion having light-transmitting properties for confirming a degree of deterioration of the first bonding portion from an outside of the first flow path member.

2. The liquid ejecting head according to claim 1, wherein
the light-transmitting portion includes a portion bonded to the first bonding portion.

3. The liquid ejecting head according to claim 2, wherein
as viewed in a lamination direction of the first flow path member and the second flow path member, the light-transmitting portion includes a first mark between a first position, which is a position of an end of the first bonding portion that defines the flow path, and a second position, which is a position of an end of the first bonding portion that does not define the flow path.

4. The liquid ejecting head according to claim 3, wherein
as viewed in the lamination direction, the light-transmitting portion includes a second mark between the second position and the first mark.

5. The liquid ejecting head according to claim 2, wherein
the first bonding portion has a property of discoloring upon contact with liquid in the flow path.

6. The liquid ejecting head according to claim 1, further comprising:
a second bonding portion, wherein
the light-transmitting portion includes a surface of the first flow path member that defines the flow path, and
the second bonding portion is bonded to the surface.

7. The liquid ejecting head according to claim 6, wherein
the second bonding portion is bonded to the surface to cover an entirety of the surface.

8. The liquid ejecting head according to claim 6, wherein
the second bonding portion is bonded to the surface to cover a part of the surface.

9. The liquid ejecting head according to claim 6, wherein
the first bonding portion and the second bonding portion are formed of the same type of adhesive.

10. The liquid ejecting head according to claim 9, wherein
a thickness of the second bonding portion is shorter than a minimum distance from a first position, which is a position of an end of the first bonding portion that defines the flow path, to a second position, which is a position of an end of the first bonding portion that does not define the flow path.

11. The liquid ejecting head according to claim 6, wherein
a liquid resistance of the second bonding portion is lower than a liquid resistance of the first bonding portion.

12. The liquid ejecting head according to claim 6, wherein
the second bonding portion has a property of discoloring upon contact with liquid in the flow path.

13. The liquid ejecting head according to claim 1, wherein
the first flow path member is positioned in a direction opposite to an ejection direction in which the nozzle ejects the liquid, with respect to a center of the liquid ejecting head on an axis along the ejection direction.

14. The liquid ejecting head according to claim 1, further comprising:
a laminate in which a plurality of flow path members defining the flow path and including the first flow path member and the second flow path member are laminated in a lamination direction, wherein
the first flow path member defines an end surface of the laminate in the lamination direction.

15. The liquid ejecting head according to claim 1, wherein
the second flow path member includes an opening portion that is open in a first direction,
the first flow path member is bonded to the second flow path member to cover the opening portion by the first bonding portion disposed around the opening portion,
as viewed in a second direction opposite to the first direction, an area of the opening portion is equal to or less than half of an area of the second flow path member that defines the flow path, and
the first flow path member is smaller than the second flow path member as viewed in the second direction.

16. The liquid ejecting head according to claim 1, wherein
the first flow path member is bonded to the second flow path member by the first bonding portion disposed around an opening portion of the second flow path member to cover the opening portion, and is in a plate shape having a substantially constant thickness.
